(19) United States
(12) Patent Application Publication
(10) Pub. No.: US 2025/0194636 A1
(43) Pub. Date: Jun. 19, 2025

(54) PLANT BASED FOOD PRODUCT AND METHOD OF ITS PRODUCTION

(71) Applicant: ALFRED'S FOODTECH LTD, Netanya (IL)

(72) Inventors: Marina KIRJNER MATANA, Rosh HaAyin (IL); Ronny REINBERG, Modiin (IL); Haim WOLFOVITZ, Binyamina (IL)

(21) Appl. No.: 18/690,043

(22) PCT Filed: Sep. 7, 2022
(86) PCT No.: PCT/IL2022/050976

§ 371 Date: Mar. 7, 2024

Related U.S. Application Data
(60) Provisional application No. 63/241,320, filed on Sep. 7, 2021.
(60) Provisional application No. 63/330,422, filed on Apr. 13, 2022.

(51) Int. Cl. A23J 3/22; A23C 20/02; A23J 3/14

(52) U.S. Cl. CPC A23J 3/227; A23C 20/025; A23J 3/14

(57) ABSTRACT

The present disclosure relates to a plant-based edible hydrogel film comprising a homogenous blend of at least one hydrocolloid forming polymer, a protein, a lipid and water; wherein said at least one hydrocolloid forming polymer comprises one or more viscosity increasing polymers, each viscosity increasing polymers having a viscosity of at least 1,000 cP at 25° C., when dissolved in water, at a concentration of about 2% (w/v); and said one or more viscosity increasing polymers being in a total amount of between 2 wt % and 20 wt % out of the total dry weight of the hydrogel film, method of preparation and uses thereof.

### TECHNOLOGICAL FIELD

The present disclosure concerns the food industry and specifically, the animal-free alternative food industry.

### BACKGROUND ART

References considered to be relevant as background to the presently disclosed subject matter are listed below:
U.S. Pat. No. 4,133,901
U.S. Pat. No. 5,106,644
US Patent Application Publication No. 2016/0278403

Acknowledgement of the above references herein is not to be inferred as meaning that these are in any way relevant to the patentability of the presently disclosed subject matter.

### BACKGROUND

U.S. Pat. No. 4,133,901 describes a process of preparing a film-shaped protein slurry, the film being used for different products. The process comprises providing a mix of protein, fat and salt at defined ranges, adding water to the mix to form a slurry, heating the slurry to form a gel, forming a film from the gelled slurry and forming therefrom products.

U.S. Pat. No. 5,106,644 describes a fat substitute and uses thereof, the fat substitute comprising up to 99.5% lipid and a polymeric liquid crystal consisting of a solvent and a polysaccharide having a molecular weight of from about 500 to 1,000,000.

US2016/0278403 describes a method for manufacturing a dry meat substitute utilizing an extruder, comprising preparing an emulsion of a vegetable protein concentrate and an emulsifier; feeding a tangible mixture into the extruder; introducing the emulsion into the tangible mixture within the extruder to form a combined material; pushing the combined material through one or more holes at an end of the extruder into an ambient environment. Also describes are edible compositions of matter comprising a vegetable protein, flour, vegetable microfiber, emulsifier, enzyme and vegetable fat.

### GENERAL DESCRIPTION

The present disclosure provides, in accordance with a first of its aspects a plant-based edible hydrogel film comprising a homogenous blend of at least one hydrocolloid forming polymer, a protein, a lipid and water;
wherein said at least one hydrocolloid forming polymer comprises one or more viscosity increasing polymers, each viscosity increasing polymer having a viscosity of at least 1,000 cP at 25° C., when dissolved in water, at a concentration of about 2% (w/v); and
said one or more viscosity increasing polymers being in a total amount of between 2 wt % and 20 wt % out of the total dry weight of the hydrogel film.

The present disclosure provides, in accordance with a second of its aspects, a method of forming a plant-based edible hydrogel film comprising
providing an emulsion composition comprising a homogenous blend of at least one hydrocolloid forming polymer, a protein, a lipid and water, wherein
said hydrocolloid forming polymer comprises one or more viscosity increasing polymers, each viscosity increasing polymers having a viscosity of at least 1,000 cP at 25° C., when dissolved in water, at a concentration of about 2% (w/v);
said one or more viscosity increasing polymers being in a total amount of between 2 wt % and 20 wt % out of the total dry weight of the blend;
forming a film from said emulsion composition; and
at least partially drying the film to obtain said plant-based edible hydrogel film.

In accordance with a third aspect, the present disclosure provides a method of producing a plant-based food product the method comprises:
(i) providing one or more emulsion compositions comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 2 wt % and 20 wt % out of the total dry weight of the food product;
(ii) forming a first film from one of the emulsion compositions;
(iii) placing on said first film at least one additional film;
wherein each film can be the same or different from a previously placed film; and
wherein each additional film is formed on a previously applied film after said previously applied film is at least partially dried.

In accordance with a fourth of its aspects, the present disclosure provides a method of producing a plant-based food product the method comprises
(i) providing an emulsion composition comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 2 wt % and 20 wt % out of the total dry weight of the food product;
(ii) folding said film into a folded film; and
(iii) at least partially drying said folded film to obtain said plant-based food product.

In accordance with a fifth aspect, the present disclosure provides a method of producing a plant-based food product the method comprises
(i) providing one or more emulsion compositions comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 2 wt % and 20 wt % out of the total dry weight of the food product;
(ii) forming a first film from one of the emulsion compositions;
(iii) placing on said first film at least one additional film to form a multiple layered film;
wherein each film can be the same or different from a previously placed film;
wherein each additional film is formed on a previously applied film after said previously applied film is at least partially dried;
(iv) cooling said multiple layered film.

### EMBODIMENTS

Some embodiments of this disclosure will now be described in the following numbered paragraph. The following description intends to add on the above general description and not limit it in any manner.

1. A plant-based edible hydrogel film comprising a homogenous blend of at least one hydrocolloid forming polymer, a protein, a lipid and water;
wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v); and
   said one or more viscosity increasing polymers being in a total amount of between 2 wt % and 20 wt % out of the total dry weight of the hydrogel film.

2. The plant-based edible hydrogel film of Embodiment 1, wherein said hydrogel forming polymer comprises a polysaccharide.

3. The plant-based edible hydrogel film of Embodiment 1 or 2, comprising two or more hydrogel forming polymers.

4. The plant-based edible hydrogel film of any one of Embodiments 1 to 3, wherein the viscosity increasing polymer comprises a polysaccharide.

5. The plant-based edible hydrogel film of Embodiment 4, wherein said viscosity increasing polymer is selected from the group consisting of methyl cellulose, hydroxypropylmethylcellulose, xanthan gum, guar gum, carboxymethylcellulose and any combination of same.

6. The plant-based edible hydrogel film of any one of Embodiments 1 to 4, wherein the viscosity increasing polymer comprises cellulose.

7. The plant-based edible hydrogel film of Embodiment 6, wherein the cellulose comprises methylcellulose (MC).

8. The plant-based edible hydrogel film of Embodiment 7, wherein the MC has a viscosity of at least about 4,000 cP at 25° C., when dissolved in water at a concentration of about 2 wt %.

9. The plant-based edible hydrogel film of Embodiment 6, wherein the cellulose comprises a hydroxypropylmethylcellulose (HPMC) having a viscosity at 25° C., of at least about 10,000 cP, or about 15,000 cP, or between about 10,000 cP and about 15,000 cP, when dissolved in water at a concentration of 2 wt %.

10. The plant-based edible hydrogel film of Embodiment 6, wherein the cellulose comprises a carboxymethylcellulose (CMC) having a viscosity at 25° C., of at least about 1,500 cP, or between about 1,500 cP and about 3,000 cP, when dissolved in water at a concentration of 1 wt %.

11. The plant-based edible hydrogel film of Embodiment 4, wherein the viscosity increasing polymer comprises a nature-derived polysaccharide.

12. The plant-based edible hydrogel film of Embodiment 11, wherein said nature-derived polysaccharide is xanthan gum having a viscosity at 25° C., of between 1,000 cP and about 2,000 cP, when dissolved in water at a concentration of 1 wt %

13. The plant-based edible hydrogel film of Embodiment 11, wherein said nature-derived polysaccharide is guar gum having a viscosity at 25° C., of at least about 3,000 cP or between about 3,000 cP and about 5,000 cP, when dissolved in water at a concentration of 1 wt %.

14. The plant-based edible hydrogel film of any one of Embodiments 1 to 13, comprising at least one hydrocolloid forming polymer other than the viscosity increasing polymer.

15. The plant-based edible hydrogel film of Embodiment 14, wherein the at least one other hydrocolloid forming polymer is a polysaccharide having a viscosity of less than 1,000 cP at 25° C., when dissolved in water, at a concentration of about 2% (w/v).

16. The plant-based edible hydrogel film of Embodiment 15, wherein the at least one other hydrocolloid forming polymer is selected from the group consisting of maltodextrin, hydroxypropylcellulose (HPC).

17. The plant-based edible hydrogel film of any one of Embodiments 1 to 16, comprising a combination of two viscosity increasing polymers.

18. The plant-based edible hydrogel film of Embodiment 17, comprising a combination of MC and HPMC.

19. The plant-based edible hydrogel film of Embodiment 18, comprising MC in an amount of at least 0.1 wt %.

20. The plant-based edible hydrogel film of Embodiment 18 or 19, comprising HPMC in an amount of at least 0.1 wt %.

21. The plant-based edible hydrogel film of any one of Embodiments 1 to 20, comprising maltodextrin.

22. The plant-based edible hydrogel film of Embodiment 21, comprising maltodextrin in an amount of at least 0.1 wt %.

23. The plant-based edible hydrogel film of Embodiment 21 or 22, comprising a combination of maltodextrin, MC and HPMC and optionally HPC.

24. The plant-based edible hydrogel film of any one of Embodiments 1 to 17, wherein said viscosity increasing polymer comprises a combination of xanthan gum and guar gum.

25. The plant-based edible hydrogel film of any one of Embodiments 1 to 17, wherein said viscosity increasing polymer comprises CMC.

26. The plant-based edible hydrogel film of any one of Embodiments 1 to 25, comprising at least one plant-based protein.

27. The plant-based edible hydrogel film of Embodiment 26, wherein said plant-based protein comprises a protein selected from the group consisting of soy, wheat, legume, soy, wheat, pea, canola, chickpea, fava bean, lentil, lupin, mung bean, navy bean, peanut, sunflower, almond, corn, oat, potato, quinoa, rice, sorghum, seitan, seeds of sort-chia, hemp, beans of sort-edamame bean, black bean, kidney bean, nuts of sort-cashews, pistachios, walnut, hazelnuts, flax and any combination of same.

28. The plant-based edible hydrogel film of Embodiment 26, wherein said plant-based protein legume protein and/or bean protein.

29. The plant-based edible hydrogel film of Embodiment 28, wherein said legume protein or bean proteins is selected from the group consisting of soy protein, pea protein, chickpea protein, lupine protein, mung-bean protein, kidney bean protein, black bean protein, alfalfa protein and any combination of same.

30. The plant-based edible hydrogel film of Embodiment 26, wherein said plant-based protein comprises at least chickpea protein.

31. The plant-based edible hydrogel film of Embodiment 28 or 29, wherein said plant-based protein comprises a combination of at least pea protein and chickpea protein.

32. The plant-based edible hydrogel film of any one of Embodiments 1 to 31, comprising an animal cell or animal cell component.

33. The plant-based edible hydrogel film of Embodiment 32, wherein said animal cell or animal cell component is selected from adipocytes, muscle cell, bone cell, connective cells, epithelial cells, fibroblast, stem cells and any combination of same.

34. The plant-based edible hydrogel film of any one of Embodiments 1 to 33, wherein said protein is selected from the group consisting of beta-gonglycinin, glycinin, vicilin, legumin, albumins, globulins, glutelins, gluten, gliadins, glutenins, mycoproteins.

35. The plant-based edible hydrogel film of any one of Embodiments 1 to 35, wherein said protein is derived from a microorganism, said microorganism selected from algae, fungi, bacteria.

36. The plant-based edible hydrogel film of any one of Embodiments 1 to 35, wherein said protein comprises a recombinantly produced protein.

37. The plant-based edible hydrogel film of Embodiment 36, wherein said recombinantly produced protein is selected from the group consisting of casein, whey protein, lactoglobulin, gelatin, hemoglobin, collagen, albumin.

38. The plant-based edible hydrogel film of any one of Embodiments 1 to 37, comprising an emulsifier.

39. The plant-based edible hydrogel film of Embodiment 38, wherein said emulsifier comprises lecithin.

40. The plant-based edible hydrogel film of Embodiment 39, wherein said lecithin is selected from the group consisting of sunflower lecithin and soy lecithin.

41. The plant-based edible hydrogel film of any one of Embodiments 1 to 40, wherein said lipid comprises plant derived oil.

42. The plant-based edible hydrogel film of Embodiment 41, wherein said plant derived oil is selected from the group consisting of canola oil, coconut oil, and any combination of same.

43. The plant-based edible hydrogel film of any one of Embodiments 1 to 42, wherein said lipid comprises short triglycerides.

44. The plant-based edible hydrogel film of any one of Embodiments 1 to 43, comprising a filler.

45. The plant-based edible hydrogel film of Embodiment 44, wherein said filler is selected from the group consisting of starch, mannitol, hydrogenated starch hydrolysates, sorbitol, sucrose, maltitol, isomalt, lactitol, maltitol, sorbitol, xylitol, erythritol, calcium carbonate and any combination thereof.

46. The plant-based edible hydrogel film of any one of Embodiments 1 to 45, comprising fibers.

47. The plant-based edible hydrogel film of Embodiment 46, wherein said fibers comprise citrus fibers.

48. The plant-based edible hydrogel film of any one of Embodiments 1 to 47, having a water content of between 20% v/v and 90% v/v.

49. The plant-based edible hydrogel film of any one of Embodiments 1 to 48, wherein said film has a thickness of between 50 μm and 3,000 μm.

50. The plant-based edible hydrogel film of any one of Embodiments 1 to 48, wherein said film being in a form of a sheet or strip.

51. The plant-based edible hydrogel film of any one of Embodiments 1 to 48, wherein said film being in a form of a thread.

52. A plant-based food product comprising at least one plant-based edible hydrogel film of any one of Embodiments 1 to 51.

53. The plant-based food product of Embodiment 52 comprising at least one plant-based edible hydrogel film being in a folded or rolled configuration.

54. The plant-based food product of Embodiment 53, comprising spirally wound plant-based edible hydrogel film.

55. The plant-based food product of Embodiment 53, comprising at least one plant-based edible hydrogel film folded in a zig-zag arrangement.

56. The plant-based food product of Embodiment 52, comprising two or more hydrogel films being essentially stacked one on top of another.

57. The plant-based food product of Embodiment 56, wherein at least a portion of each edible hydrogel film is adhered to its neighboring film.

58. The plant-based food product of Embodiment 56 or 57, comprising a plurality of the same or different plant based edible hydrogel films.

59. The plant-based food product of any one of Embodiments 52 to 58, being a plant-based meat analogue or a plant based dairy analogue.

60. A plant-based chicken meat analogue product comprising at least two plant-based edible hydrogel films, each film, which can be the same or different, comprise a homogenous blend of hydrocolloid forming polymers, a protein, a lipid and water; wherein
(a) said hydrocolloid forming polymers are in an amount of between about 11.8 wt % and about 12.1 wt % out of the total dry weight of the meat analogue,
(b) said hydrocolloid forming polymers comprise at least two viscosity increasing polymers, each viscosity increasing polymers having a viscosity of at least 4,000 cP at 25° C., when dissolved in water, at a concentration of about 2% (w/v);
(c) said at least two viscosity increasing polymers are in a total amount of between about 10 wt % and about 10.5 wt % out of the total dry weight of the meat analogue; and
(d) said at least two viscosity increasing polymers comprise HPMC and MC.

61. The plant-based chicken meat analogue product of Embodiment 60, wherein the two viscosity-increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

62. The plant-based chicken meat analogue product of Embodiment 60 or 61, comprising maltodextrin in an amount of about 5.7 wt %, sunflower lecithin in an amount of about 6.7 wt %, medium chain triglyceride (MCT) in an amount of about 16.2 wt %, canola oil in an amount of about 16.7 wt %, pea protein in an amount of about 13.3 wt %, chickpea protein in an amount of about 8.3 wt %, salt in an amount of about 3.3 wt %, citrus fibers in an amount of about 4 wt %, mannitol in an amount of about 5.3 wt % and flavoring and colorants, each amount being out of the total dry weight of the food product.

63. A plant-based chicken meat analogue product comprising at least two hydrogel films, each film, which can be the same or different, comprise a homogenous blend of a hydrocolloid forming polymer, a protein, a lipid and water; wherein
(a) said hydrocolloid forming polymer comprises at least two viscosity increasing polymers, each viscosity increasing polymers having a viscosity of at least 4,000 cP at 25° C., when dissolved in water, at a concentration of about 2% (w/v)
(b) said two viscosity increasing polymers being in a total amount of between about 7.1 wt % and about 7.3 wt % out of the total dry weight of the food product; and
(c) said viscosity increasing polymers comprise HPMC and MC.

64. The plant-based chicken analogue product of Embodiment 63, wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

65. The plant-based chicken meat analogue product of Embodiment 63 or 64, comprising maltodextrin in an amount of about 4.2 wt %, sunflower lecithin in an amount of about 5.5 wt %, canola oil in an amount of about 23.3 wt %, pea protein in an amount of about 11.7 wt %, chickpea protein in an amount of about 20.0 wt %, salt in an amount of about 1.7 wt %, citrus fibers in an amount of about 7.3 wt %, mannitol in an amount of about 8.3 wt % and flavoring and colorants, each amount being out of the total dry weight of the food product.

66. A plant-based chicken meat analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymers having a viscosity of at least 4,000 cP at 25° C., when dissolved in water, at a concentration of about 2% (w/v);
(b) said at least two viscosity increasing polymers comprise HPMC and MC, being in a total amount of between about 8.6 wt % and about 8.8 wt % out of the total dry weight of the chicken meat analogue product.

67. The plant-based chicken meat analogue product of Embodiment 66, wherein said two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

68. The plant-based chicken meat analogue product of Embodiment 66 or 67, comprising maltodextrin in an amount of about 5.3 wt %, sunflower lecithin in an amount of about 6.7 wt %, canola oil in an amount of about 30.5 wt %, chicken muscle cell in an amount of about 11.5 wt %, salt in an amount of about 3.3 wt %, citrus fibers in an amount of about 4.2 wt %, mannitol in an amount of about 10.7 wt % and flavoring and colorants, each amount being out of the total dry weight of the chicken analogue.

69. The chicken meat analogue product of Embodiment 66 or 67, comprising maltodextrin in an amount of about 5.3 wt %, sunflower lecithin in an amount of about 6.7 wt %, canola oil in an amount of about 30.5 wt %, fish adipocyte cells in an amount of about 18.3 wt %, salt in an amount of about 3.3 wt %, citrus fibers in an amount of about 4.0 wt %, mannitol in an amount of about 13.7 wt % and flavoring and colorants, each amount being out of the total dry weight of the chicken analogue.

70. A plant-based ham analogue product comprising at least two plant-based hydrogel films, each film, which can be the same or different, comprise a homogenous blend of hydrocolloid forming polymers, a protein, a lipid and water; wherein
(a) said hydrocolloid forming polymer comprises at least two viscosity increasing polymers, each viscosity increasing polymers having a viscosity of at least 4,000 cP at 25° C., when dissolved in water, at a concentration of about 2% (w/v);
(b) said at least two viscosity increasing polymers comprising MC and HPMC in a total amount of between about 11.6 wt % and about 12.0 wt % out of the total dry weight of the ham analogue product.

71. The plant-based ham analogue product of Embodiment 70, wherein said two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

72. The plant-based ham analogue product of Embodiment 70 or 71, comprising maltodextrin in an amount of about 5.2 wt %, sunflower lecithin in an amount of about 8.3 wt %, medium chain triglyceride (MCT) in an amount of about 16.7 wt %, canola oil in an amount of about 17.3 wt %, pea protein in an amount of about 10.0 wt %, chickpea protein in an amount of about 10.0 wt %, salt in an amount of about 1.8 wt %, citrus fibers in an amount of about 3.3 wt %, mannitol in an amount of about 5.3 wt % and flavoring and colorants, each amount being out of the total dry weight of the plant based ham analogue.

73. A plant-based bacon analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymers having a viscosity of at least 4,000 cP at 25° C., when dissolved in water, at a concentration of about 2% (w/v);
(b) said at least two viscosity increasing polymers being in a total amount of between about 11.2 wt % and about 11.6 wt % out of the total dry weight of the bacon analogue product; and
(c) said at least two viscosity increasing polymers comprise HPMC and MC.

74. The plant-based bacon analogue product of Embodiment 73, wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

75. The plant-based bacon analogue product of Embodiment 73 or 74, comprising maltodextrin in an amount of about 4.2 wt %, sunflower lecithin in an amount of about 8.0 wt %, medium chain triglyceride (MCT) in an amount of about 16.7 wt %, canola oil in an amount of about 16.7 wt %, pea protein in an amount of about 10.0 wt %, chickpea protein in an amount of about 10.0 wt %, salt in an amount of about 2.3 wt %, citrus fibers in an amount of about 3.7 wt %, mannitol in an amount of between about 3.2 wt % and about 4.8 wt % and flavoring and colorants, each amount being out of the total dry weight of the bacon analogue product.

76. A plant-based cheese analogue product comprising at least two plant-based edible hydrogel films, each edible hydrogel film, which can be the same or different, comprise a homogenous blend of hydrocolloid forming polymers, a protein, a lipid and water; wherein
(a) said hydrocolloid forming polymers comprise at least one viscosity increasing polymer having a viscosity of at least 4,000 cP at 25° C., when dissolved in water, at a concentration of about 2% (w/v)
(b) said at least one viscosity increasing polymer being in a total amount of about 3.0 wt % out of the total dry weight of the cheese analogue product; and
(c) said at least one viscosity increasing polymer comprise MC.

77. The plant-based cheese analogue product of Embodiment 76, wherein said at least one viscosity increasing polymer comprise or consist essentially of MC having a viscosity of about 4,000 cP at 25° C., when dissolved in water, at a concentration of about 2% (w/v).

78. The plant-based cheese analogue product of Embodiment 76 or 77, comprising maltodextrin in an amount of about 3.0 wt %, sunflower lecithin in an amount of about 9.0 wt %, medium chain triglyceride (MCT) in an amount of about 16.7 wt %, canola oil in an amount of about 17.9 wt %, coconut oil in an amount of about 27 wt %, chickpea protein in an amount of about 4.5 wt %, whey protein in an amount of about 6.7 wt %, casein protein in an amount of about 6.7 wt %, salt in an amount of about 1.5 wt %, mannitol in an amount of about 7.5 wt %, calcium carbonate in an amount of about 4.5 wt %, yeast extract in an amount of about 5.2 wt % and flavoring and colorants, each amount being out of the total dry weight of the cheese analogue product.

79. A plant-based salmon meat analogue product comprising at least two hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymer having a viscosity of at least 4,000 cP at 25° C., when dissolved in water, at a concentration of about 2% (w/v);
(b) said at least two viscosity increasing polymers comprise HPMC and MC, being in a total amount of about 8.7 wt % out of the total dry weight of the salmon meat analogue product.

80. The plant-based salmon meat analogue product of Embodiment 79, wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

81. A plant-based yellow cheese analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing forming polymers, each viscosity increasing forming polymers having a viscosity of at least 1,000 cP at 25° C., when dissolved in water, at a concentration of about 2% (w/v);
(b) said two viscosity increasing hydrocolloid forming polymers comprises xanthan gum and guar gum in a total amount of about 12.2 wt % out of the total dry weight of the yellow cheese analogue product.

82. The plant-based yellow cheese analogue product of Embodiment 81, comprising sunflower lecithin in an amount of about 10.4 wt %, canola oil in an amount of about 20.9 wt %, coconut oil in an amount of about 20.9, pea protein in an amount of about 6 wt %, chickpea protein in an amount of about 17.9 wt %, salt in an amount of about 1.8 wt %, mannitol in an amount of about 3.0 wt %, yeast extract in an amount of about 1.2 wt % and flavoring and colorants, each amount being out of the total dry weight of the yellow cheese analogue.

83. A plant-based hard cheese analogue product comprising at least two plant-based edible hydrogel films, each film, which can be the same or different, comprise a homogenous blend of at least one hydrocolloid forming polymer, a protein, a lipid and water; wherein
(a) said at least one hydrocolloid forming polymer comprise at least one viscosity increasing polymer having a viscosity of at least 1,500 cP at 25° C., when dissolved in water, at a concentration of about 2% (w/v);
(b) said at least one viscosity increasing polymer comprises CMC in an amount of about 3.0 wt % out of the total dry weight of the hard cheese analogue product; and
(c) said homogenous blend comprises starch in an amount of about 11.9 wt %.

84. The plant-based hard cheese analogue product of Embodiment 83, comprising sunflower lecithin in an amount of about 7.5 wt %, canola oil in an amount of about 16.4 wt %, coconut oil in an amount of about 16.4, pea protein in an amount of about 6.0 wt %, chickpea protein in an amount of about 17.9 wt %, salt in an amount of about 1.5 wt %, mannitol in an amount of about 11.5 wt %, yeast extract in an amount of about 3.0 wt % and flavoring and colorants, each amount being out of the total dry weight of the food product.

85. A method of forming a plant-based edible hydrogel film comprising
(a) providing an emulsion composition comprising a homogenous blend of at least one hydrocolloid forming polymer, a protein, a lipid and water, wherein
   (b) said hydrocolloid forming polymer comprises one or more viscosity increasing polymers, each viscosity increasing polymers having a viscosity of at least 1,000 cP at 25° C., when dissolved in water, at a concentration of about 2% (w/v);
   (c) said one or more viscosity increasing polymers being in a total amount of between 3 wt % and 20 wt % out of the total dry weight of the blend;
(d) forming a film from said emulsion composition; and
(e) at least partially drying the film to obtain said plant-based edible hydrogel film.

86. The method of Embodiment 84, wherein said forming of the film is by spreading a mass of the emulsion composition onto a film forming bed or within a mold.

87. The method of Embodiment 86, comprising controlling thickness of the film.

88. The method of Embodiment 87, wherein said controlling of thickness of the film is by using a gap applicator.

89. The method of any one of Embodiments 84 to 88, wherein said at least partially drying of the film is by exposing the film to a controlled heat.

90. The method of any one of Embodiments 84 to 88, wherein said at least partially drying the film is by any one or combination of heating the film within an oven, exposing the film to drying air, exposing the film to infrared (IR) radiation or heating within a microwave.

91. The method of any one of Embodiments 85 to 90, wherein said at least partially drying of the film is until water content within the film is between 20% and 90%.

92. The method of any one of Embodiments 85 to 91, wherein said hydrogel film is as defined in any one of Embodiments 1 to 51.

93. A method of producing a plant-based food product the method comprises
(i) providing one or more emulsion compositions comprising a homogenous blend of at least one hydrocolloid forming polymer, a protein, a lipid and water; wherein
   (b) said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   (c) said one or more viscosity increasing polymers being in a total amount of between 3 wt % and 20 wt % out of the total dry weight of the food product;
(ii) forming a first film from one of the emulsion compositions;
(iii) placing on said first film at least one additional film;
wherein each film can be the same or different from a previously placed film; and
wherein each additional film is formed on a previously applied film after said previously applied film is at least partially dried.

94. The method of Embodiment 93, comprising stacking a plurality of films one on top of another.

95. The method of Embodiment 94, wherein at least part of the plurality of films are formed prior to being stacked one on top of another.

96. The method of Embodiment 95, wherein at least part of the films are formed by spreading the emulsion composition onto a film forming bed or within a mold to form a film with a defined thickness and at least partially drying the thus formed film.

97. A method of producing a plant-based food product the method comprises
(i) providing an emulsion composition comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 3 wt % and 20 wt % out of the total dry weight of the food product;
(ii) folding said film into a folded film; and
(iii) at least partially drying said folded film to obtain said plant-based food product.

98. The method of any one of Embodiments 93 to 97, wherein the at least partially drying is by any one or combination of heating within an oven, exposing to drying air, exposing to IR radiation or heating within a microwave.

99. The method of any one of Embodiments 93 to 98, comprising controlling thickness of each film.

100. The method of Embodiment 99, wherein said thickness is between 50 μm and 3,000 μm.

101. A method of producing a plant-based food product the method comprises
(i) providing one or more emulsion compositions comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 2 wt % and 20 wt % out of the total dry weight of the food product;
(ii) forming a first film from one of the emulsion compositions;
(iii) placing on said first film at least one additional film to form a multiple layered film;
wherein each film can be the same or different from a previously placed film;
wherein each additional film is formed on a previously applied film after said previously applied film is at least partially dried; and
(iv) reducing the temperature of said multiple layered film.

102. The method of Embodiment 101, wherein said reducing the temperature is to a temperature of at most 10° C.

103. The method of Embodiment 101 or 102, comprising drying said multiple layered film.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a photographic image of a plant-based chicken style cold cut comprising a single hydrogel film according to the non-limiting Example 1 of the present disclosure.

FIG. 2 is a photographic image of a plant-based chicken style cold cut comprising two layers (marked as “20” and “22” in the Figure) of a hydrogel according to the non-limiting Example 2 of the present disclosure

FIG. 3 is a photographic image of a plant-based ham style cold cut comprising a single hydrogel film according to the non-limiting Example 3 of the present disclosure

FIG. 4 is a photographic image of a plant-based bacon style cold cut comprising a single hydrogel film according to the non-limiting Example 4 of the present disclosure, and showing the presence of two distinct colors

FIG. 5 is a photographic image of a plant-based chicken style cold cut comprising a single rolled hydrogel film according to the non-limiting Example 5 of the present disclosure.

FIG. 6 is a photographic image of a plant-based chicken style breast comprising 8 layered hydrogel films according to the non-limiting Example 6 of the present disclosure

FIG. 7 is a photographic image of a plant-based breaded chicken style breast comprising 9 layered films (Schnitzel) according to the non-limiting Example 7 of the present disclosure

FIG. 8 is a photographic image of a plant-based hybrid hard cheese comprising 3 layers of a hydrogel film including plant based as well as bovine protein (whey protein and casein) according to the non-limiting Example 8 of the present disclosure

FIG. 9 is a schematic illustration of a single rolled film comprising a hybrid chicken style cold cut with chicken muscle cells according to the non-limiting Example 9 of the present disclosure

FIG. 10 is a schematic illustration of a single rolled film comprising a hybrid Salmon style fish with fish adipocytes according to the non-limiting Example 10 of the present disclosure

FIG. 11 is a photographic image of a plant-based yellow cheese comprising three layers of a hydrogel film according to the non-limiting Example 11 of the present disclosure

FIG. 12 is a photographic image of a plant-based Feta cheese comprising three layers of a hydrogel film according to the non-limiting Example 12 of the present disclosure

FIG. 13 is a photographic image of plant-based elongated threads prepared by an exemplary method of pressing an emulsion through a set of nozzles.

FIG. 14 is a photographic image of a plant-based breaded chicken tenders showing thread/fibril structure.

FIG. 15 is a photographic image of a plant-based chicken style breast after over-drying, showing thread/fibril structure.

FIG. 16 is a schematic representation of a mold for preparation of thread in accordance with some embodiments.

FIG. 17 is a photographic image of a plant-based chicken style breast comprising a single over-thick layer.

FIG. 18 is a photographic image of a plant-based film comprising viscosity increasing polymers in an amount below 2%, thus outside the scope of the present disclosure, which resulted in lack of continuity within the film.

FIG. 19 is a photographic image salmon thread/fibril structure.

FIG. 20 is a photographic image of a plant-based salmon showing elongated threads.

FIG. 21 is a photographic image of the resulting Salmon fillet analogue product, showing fibril structure.

FIG. 22 is a photographic image of an exemplary hydrogel film, for clarity, the height (thickness) of the film is indicated with an arrow.

### DETAILED DESCRIPTION

The present disclosure provides a plant-based hydrogel film with intentionally designed properties that make it suitable at part plant-based food products that may have a commercial benefit as alternatives or analogues to animal-based foods.

The plant-based hydrogel film, and consequently the food products comprising the same, are based on the realization that some rheological properties, such as chewiness, can be achieved when incorporating within the film a selected type of hydrogel forming polymers having a defined viscosity range, and at a defined weight range.

Thus, in the context of a first of its aspects, the present disclosure provides a plant-based edible hydrogel and specifically, a plant based edible hydrogel film comprising a homogenous blend of at least one hydrocolloid forming polymer, at least one protein, at least one lipid and water; wherein
the at least one hydrocolloid forming polymer comprises one or more viscosity increasing polymers, each viscosity increasing polymers having a viscosity of at least 1,000 cP at 25° C., when dissolved in water, at a concentration of about 2% (w/v); and
the one or more viscosity increasing polymers being in a total amount of between 2 wt % and 20 wt % out of the total dry weight of the hydrogel film.

In the context of the present disclosure when referring to a “plant-based” film or “plant-based” product it is to be understood to refer to a film or product that comprises, although not exclusively, plant derived components. The plant derived component can be a protein(s), a lipid(s), a polymer(s), a low molecular weight compound(s) and any combination of same and can be derived from a whole plant of from part thereof, such as from the fruit, the leaf, the seed, the bulb, etc.

In some examples, when referring to a plant-based film or product it is to be understood to encompass films or products that are essentially animal free, meaning that it does not contain components that are directly derived from a leaving animal or in other words, the component(s) are not obtained via the direct exploitation of animals e.g. it is dairy free, and meat free. In this context, the plant-based film or product can include cultured animal cells, recombinant cells and/or components from animal cell culture (native or recombinant), as further described hereinbelow.

In some other examples, the film can include animal components, such as those that are recombinantly produced. For example, and without being limited thereto, the film can include one or more recombinantly produced milk proteins.

The hydrogel film or product containing the hydrogel film is edible, namely, suitable for human consumption.

Further, in the context of the present disclosure, when referring to “hydrogel film” it is to be understood to encompass a three-dimensional hydrogel product having a height (thickness), length and width, wherein one of its dimensions, being the film's height, is up to about 8 mm, at times up to about 7 mm, at times up to about 6 mm, at times up to about 4 mm, at times up to about 2 mm, at times up to about 1 mm as further discussed below.

The hydrogel is a physically hydrogel, i.e. one that can undergo a transition from liquid to a gel in response to a change in environmental conditions such as temperature, ionic concentration, pH, or other conditions such as mixing of two components. This is opposed to chemical gels which involve covalent bonding.

In some examples, the hydrogel is one which under appropriate conditions, disintegrates after more than 3 minutes. In some examples, the disintegration time is evaluated on a sample having an area of 1 cm² and the sample volume is dependent on the individual product's thickness, placed in a pre-heated water (37° C., 100 ml) and stirred using a magnetic stirrer.

The edible hydrogel film disclosed herein is made of a homogenous blend of one or more hydrocolloid forming polymers, one or more proteins, one or more lipids (fats and/or oils) and water.

The term “hydrocolloid forming polymer” used herein denotes any polymer or combination of polymers, which may be natural, synthetic and/or semi-synthetic that forms a gel when mixed with water. The polymer(s) is one capable, under appropriate conditions, to form into a hydrocolloid matrix.

Hydrocolloids are often called hydrophilic polymer that generally contain many hydroxyl groups (e.g. polysaccharides) and may be polyelectrolytes, for example, alginate, carrageenan, methylcellulose, hydroxypropylmethylcellulose, hydroxyproplylcellulose, carboxymethylcellulose, gum arabic, chitosan, pectin, and xanthan gum.

In some examples, the hydrocolloid forming polymer comprises at least one polysaccharide (also denoted as polycarbohydrate)

In some examples, the polysaccharide is at least one polyelectrolyte.

In some embodiments, the polysaccharide is a linear polysaccharide, a branched polysaccharide or a combination thereof. In some embodiments, the polysaccharide is a linear polysaccharide. In some embodiments, the polysaccharide is a branched polysaccharide.

In some embodiments, the polysaccharide is an anionic polysaccharide.

In some embodiments, the polysaccharides is a homo-polysaccharide, a hetero-polysaccharide or a combination thereof. In some embodiments, the polysaccharides is a homo-polysaccharide. In some embodiments, the polysaccharides is a hetero-polysaccharide.

In some embodiments, the polysaccharides is any one of at least one of a storage polysaccharide or at least one of a structural polysaccharide.

The polysaccharide can be in accordance with the present disclosure can be a polysaccharide from any source and include any one of at least one native polysaccharide, at least one modified polysaccharide, at least one hydrolysate polysaccharide or any combination thereof.

In some embodiments, the polysaccharide is any one of at least one cellulose and/or at least one starch and/or at least one chitin, and/or at least one of arabinoxylan and/or at least one of pectin.

In some embodiments, the polysaccharide is at least one cellulose and derivative thereof. In some other embodiments, the polysaccharide is at least one starch. In some embodiments, the polysaccharide is at least one chitin. In some embodiments, the polysaccharide is at least one arabinoxylan. In some embodiments, the polysaccharide is at least one pectin.

In some embodiments, the polysaccharide is at least one of alginate, carrageenan, methylcellulose, hydroxypropylmethylcellulose, hydroxyproplylcellulose, carboxymethylcellulose, gum arabic, chitosan, pectin, guar gum, agar, gellan gum, gum karaya, gum tragacanth, konjac mannan, locust beam gum, xanthan gum, starch or any combination thereof.

In some examples, the polysaccharide comprises at least one fiber.

In some examples, the polysaccharide comprises at least one cellulose, chitin, lignin, xanthan gum, starch, arabinoxylan, fructans, inulin, pectin, alginate, agar, carrageenan, polydextrose.

The fibers may be from any source including, inter alia, a fruit, a vegetable, a cereal, a legume or algae

In some examples, the hydrocolloid forming polymer comprises two or more polymers that under appropriate conditions form a hydrogel film.

It was suggested, the amount of the at least one hydrocolloid forming polymer is selected to allow one hand formation of an intact, continuous structure of the film and on the other hand an organoleptic texture and taste.

In the context of the present disclosure an intact, continuous film structure is characterized by a film with essentially no cracks as determined visually.

In some embodiments, the at least one hydrocolloid forming polymer is in an amount of at least about 1% out of the total dry weight of the hydrogel film, at times at least about 2%, at times at least about 3%, at times at least about 3.5%, at times at least about 4%, at times at least about 4.5%, at times at least about 5%, at times at least about 5.5%, at times at least about 6%, at times at least about 6.5%, at times at least about 7%, at times at least about 7.5%, at times at least about 8%, at times at least about 8.5%, at times at least about 9%, at times at least about 9.5%, at times at least about 10%, at times at least about 11%, at times at least about 12%, at times at least about 13%, at times at least about 14%, at times at least about 15%, at times at least about 16% out of the total dry weight of the hydrogel film.

In some embodiments, the at least one hydrocolloid forming polymer is in an amount of between about 3% and about 20% out of the total dry weight of the hydrogel film, at times between about 3% and about 15%, at times between about 3% and about 20%, between about 3% and about 15% out of the total dry weight of the hydrogel film.

In some embodiments, the at least one hydrocolloid forming polymer is in an amount of between about 3% and about 25% out of the total dry weight of the hydrogel film, at times between about 4% and about 25%, at times between about 5% and about 25%, between about 6% and about 25%, between about 7% and about 25%, between about 8% and about 25%, between about 9% and about 25% out of the total dry weight of the hydrogel film.

In some embodiments, the at least one hydrocolloid forming polymer is in an amount of between about 9.5% and about 25% out of the total dry weight of the hydrogel film, at times between about 10% and about 25%, at times between about 11% and about 25%, between about 12% and about 25%, between about 15% and about 25% out of the total dry weight of the hydrogel film.

In some examples, the hydrocolloid forming polymer is selected to increase the viscosity of the resulting polymer. Such polymers are referred to herein by the term “viscosity increasing polymer”.

In the context of the present disclosure when using the term “viscosity increasing polymer” it is understood to encompass a polymer that when dissolved in water at 25° C., and at a concentration of at least 1% (w/v), at times at least 2% (w/v) the resulting hydrocolloid has a viscosity of about 1,000 cP; at times, at least 2,000 cP.

In some examples, the one or more viscosity increasing polymer has a viscosity of at least 1,000 cP at 25° C., when dissolved in water, at a concentration of about 1% (w/v).

In some examples, the one or more viscosity increasing polymer has a viscosity of at least 1,000 cP at 25° C., when dissolved in water, at a concentration of about 2% (w/v).

In some examples, the one or more viscosity increasing polymer has a viscosity of at least 2,000 cP at 25° C., when dissolved in water, at a concentration of about 1% (w/v).

In some examples, the one or more viscosity increasing polymer has a viscosity of at least 1,000 cP at 25° C., when dissolved in water, at a concentration of about 2% (w/v).

In some embodiments, the one or more viscosity increasing polymers is in a total amount of between about 1.5 wt % and about 20 wt %, at times between about 2 wt % and about 20 wt % out of the total dry weight of the hydrogel film, at times between about 2 wt % and about 17 wt %, at times between about 2 wt % and about 16 w %.

In some examples, the viscosity increasing polymer comprises a polysaccharide.

In some examples, the viscosity increasing polymer comprises a cellulose.

In the context of the present disclosure, the term “cellulose” is used to denote natural cellulose as well as cellulose derivatives. In some examples, the viscosity increasing polymer comprises one or more cellulose derivatives.

Cellulose derivatives are typically cellulose ether derivatives or cellulose ester derivatives, the latter typically being water insoluble. Thus, in the context of the present disclosure, when referring to cellulose derivatives it is to be understood to encompass cellulose ether derivatives. These include, without being limited thereto, Methyl cellulose (MC), Ethyl cellulose (EC), Hydroxyethyl cellulose (HEC), Hydroxypropyl cellulose (HPC), hydroxypropylmethyl cellulose (HPMC), carboxymethyl cellulose (CMC) and sodium carboxymethyl cellulose (NaCMC). When used as viscosity increasing polymers, these will be selected to provide a viscosity of at least 1,000 cP under the conditions described herein.

In some examples, the viscosity increasing polymer comprises at least methyl cellulose (MC) having, at 25° C., a viscosity of about 4,000 cP after dissolution in water at a concentration of 2 w/v %.

In some examples, when the viscosity increasing polymer comprises MC with the viscosity defined herein, it is present in an amount of at least 2 wt %, at times between 2 wt % and 11 wt %. In some examples, if present, the MC is in amount of between 3 wt % and 11 wt %; at times between 4 wt % and 11 wt %; at times between 5 wt % and 11 wt %; at times between 2 wt % and 5 wt %; at times between 2 wt % and 6 wt %; at times between 3 wt % and 7 wt %; at times between 4 wt % and 8 wt %; at times between 5 wt % and 9 wt %, at times between 2 wt % and 5 wt %, at times between 2 wt % and 7 wt %, at times between 2 wt % and 9 wt %, at times between 2 wt % and 10 wt %.

In some examples, the viscosity increasing polymer comprises at least hydroxypropylmethylcellulose (HPMC) having, at 25° C., a viscosity of at least about 4,000 cP; or at times at least about 5,000 cP; or at times at least about 6,000 cP; or at times at least about 7,000 cP; or at times at least about 8,000 cP; or at times at least about 9,000 cP; or at time at least about 10,000 cP, or at times of at least about 11,000 cP, or at times at least about 12,000 cP, or at times at least about 13,000 cP, or at times at least about 14,000 cP, or at times between about 10,000 cP and about 15,000 cP or about 15,000 cP, after dissolution in water at a concentration of 2 w/v %.

In some examples, the viscosity increasing polymer comprises at least hydroxypropylmethylcellulose (HPMC) having, at 25° C., a viscosity of at least about 12,000 cP, or at times at least about 13,000 cP, or at times at least about 14,000 cP, or at times between about 10,000 cP and about 15,000 cP or about 15,000 cP, after dissolution in water at a concentration of 2 w/v %.

In some examples, when the viscosity increasing polymer comprises HPMC with the viscosity defined herein, it is present in an amount of at least 0.5 wt %, at times between 0.5 wt % and 2 wt %. In some examples the amount of the HPMC (with the viscosity defined herein) is between 0.5 wt % and 1.5%; at times between 0.5 wt % and 1 wt %, at times between 1.0 wt % and 2 wt %, at times between 1 wt % and 1.5 wt %.

In some examples, the viscosity increasing polymer comprises at least xanthan gum having, at 25° C., a viscosity of between about 1,000 cP and about 2,000 cP, after dissolution in water at a concentration of 1 w/v %.

In some examples, when the viscosity increasing polymer comprises xanthan gum with the viscosity defined herein, it is present in an amount of at least 2 wt %, at times between 2 wt % and 5 wt %. In some examples, the xanthan gum, if present, is in an amount of between about 2 wt % and 4 wt %, at times between 2.5 wt % and 5 wt %.

In some examples, the viscosity increasing polymer comprises at least guar gum having, at 25° C., a viscosity of between about 3,000 cP and 5,000 cP after dissolution in water at a concentration of 1 w/v %.

In some examples, when the viscosity increasing polymer comprises guar gum with the viscosity defined herein, it is present in an amount of about 2% (w/v), at times between 11 wt % and 12 wt %. In some examples, the guar gum, if present, is in an amount of between about 11.2 wt % and 12 wt %; at times between about 11.4% and 12 wt %.

In some examples, the viscosity increasing polymer comprises at least carboxymethylcellulose (CMC) having, at 25° C., a viscosity of at least about 1,500 cP, or between about 1,500 cP and about 3,000 cP, after dissolution in water at a concentration of 1 w/v %.

In some examples, when the viscosity increasing polymer comprises CMC with the viscosity defined herein, it is present in an amount of at least 2 wt %, at times between 2 wt % and 5 wt %. In some examples, the CMC with the defined viscosity is in an amount of between 2 wt % and 4.5 wt %; at times between 2.5 wt % and 5 wt %.

In some examples, the viscosity increasing polymer comprises one or more polymers selected from the group consisting of methyl cellulose, hydroxypropylmethylcellulose, xanthan gum, guar gum, carboxymethylcellulose and any combination of same, each having a viscosity at 1% as defined herein.

In some examples, the viscosity increasing polymer comprises a natural polysaccharide. This includes, without being limited thereto, guar gum, xanthan gum, carrageenan, locust bean gum, gum karaya, gum tragacanth, gum arabic, alginate, pectin's polyvinyl alcohol-polyethylene glycol graft copolymer.

In some examples, the edible hydrogel film comprises a combination of two viscosity increasing polymers.

In some examples, the edible hydrogel film comprises a combination of combination of MC and HPMC, each having a viscosity at 1% concentration of at least 1,000 cP, when measured at 25° C.

In some examples, the edible hydrogel film comprises a combination of MC in an amount of at least 0.1 wt %, at times at least 1 wt %, at times at least 2 wt % or between 0.1 wt % and 11 wt % or between 1 wt % and 11 wt % or between 2 wt % and 11 wt % out of the total dry weight of the film and HPMC in an amount of at least 0.5 wt % or between 0.5 wt % and 2 wt % out of the total dry weight of the film.

The hydrogel forming polymer can include at least one additional polymer that does not fall under the above definition for the viscosity increasing polymers, namely, when dissolved in water at a concentration of about 2%, the viscosity of the resulting hydrogel, at 25° C., is less than 1,000 cP. The additional polymer is thus a hydrogel forming polymer, however, with a lower viscosity under the viscosity determination conditions provided herein.

In some examples, the additional hydrogel forming polymer (that is not the viscosity increasing polymer) is a polysaccharide.

In some examples, the additional hydrogel forming polymer comprises or is maltodextrin.

In some examples, the additional film forming polymer comprises or is hydroxypropylcellulose (HPC) with a molecular weight of between about 50 kDa and 1,250 KDa.

In some examples, the additional hydrogel forming polymer comprises or is maltodextrin. In some examples, when using maltodextrin, it is in an amount of at least 0.1 wt %, at times at least 1 wt %, at least about 2 wt %; at times, at least 3 wt %; or at times at least 4 wt %; or at times at least 5 wt %. At times, the amount of maltodextrin is between 2 wt % and about 10 wt %, at times, between 2 wt % and 7 wt %; at times, between about 3 wt % and 6 wt %.

In some examples, the hydrogel forming polymer and hence the edible film comprise a combination of maltodextrin, MC and HPMC. In these non-limiting examples, the amount of each polymer is about 4 wt %-6 wt % maltodextrin, about 9 wt %-11 wt % MC and about 0.6 wt %-1.5 wt % for HPMC.

In some examples, the hydrogel forming polymer and hence the edible film comprise a combination of maltodextrin, MC, HPMC and HPC. In these non-limiting examples, the amount of each polymer is about 4 wt %-6 wt % maltodextrin, about 6 wt %-11 wt % MC, about 0.5 wt %-1.5 wt % for HPMC and about 1.2 wt %-3 wt % for HPC. In some examples, the hydrogel forming polymer and hence the edible film comprises a combination of xanthan gum and guar gum. In these non-limiting examples, the amount of each polymer is about 3 wt % for xanthan gum and about 11.9 wt % for guar gum.

In some examples, the hydrogel forming polymer and hence the edible film comprise CMC. In these non-limiting examples, the amount of CMC is about 3 wt %.

The edible hydrogel film comprises proteins.

In some examples, the protein is a plant derived protein. When referring to “plant derived protein” it is to be understood to encompass any protein that is extracted from a plant part. The extracted protein material can be a protein isolate, i.e. including at least 90% protein material and 10% components from the plant that are non-proteinous (fibers, lipids/fat, carbohydrates, ash etc); the extracted protein material can be a protein concentrate, i.e. including about 70% or more protein material and up to 30% components from the plant that are non-proteinous.

It should be noted that the plant derived protein may be in a form of a plant concentrate or plant isolate. A plant concentrate or plant isolate, may include in addition to the plant protein per se additional components. Hence, a plant concentrate, or plant isolate comprise plant protein and at least one hydrocolloid forming polymer including viscosity increasing polymer. Such hydrocolloid forming polymer include cellulose derivates, different gums, fibers, starches and others.

The plant derived protein can be obtained from various plants. It can include protein from a single plant or from different plants, namely, protein from different plant sources.

In some examples, the plant is selected from the group consisting of soy, wheat, legume, lentil, lupin, mung bean, navy bean, peanut, sunflower, almond, corn, oat, potato, quinoa, rice, sorghum, seitan, seeds of sort-chia, hemp, beans of sort-edamame bean, black bean, kidney bean, nuts of sort-cashews, pistachios, walnut, hazelnuts, flax.

In some examples, the protein is selected from the group consisting of soy protein, pea protein, chickpea protein, lupine protein, mung-bean protein, kidney bean protein, black bean protein, alfalfa protein, almond protein, and any combination of same.

In some examples, the plant is legume, i.e. the protein is legume protein, preferably at least chickpea protein.

In some examples, the plant protein comprises a combination of at least pea protein and chickpea protein.

In some embodiments, the plant protein is an almond protein.

In some examples, the plant based edible hydrogel film comprises a protein selected from the group consisting of beta-gonglycinin, glycinin, vicilin, legumin, globulins, glutelins, gluten, gliadins, glutenins.

In some examples, the plant based edible hydrogel film comprises mycoproteins.

In some examples, the edible film comprises protein that is not from a plant source. This may include recombinantly produced protein or protein sourced from cell culture.

In some examples, the edible hydrogel film comprises an animal cell or animal cell component, typically providing the protein material.

When using an animal cell as protein source it is to be understood to encompass cultured cells, that do not involve for their production the slaughtering of animals. These in vitro grown cells can be produced in bioreactors and then combined into the homogenous blend after being isolated from the culture medium. In some examples, the cells can be added during emulsion preparation as done with other ingredients (see for example, non-limiting Examples 8-10 below).

In some examples, the cells are selected from the non-limiting group of adipocytes, muscle cell, bone cell, connective cells, epithelial cells, fibroblast, stem cells and any combination of same.

In some examples, the cells originate from any member of the porcine, bovine, ovine, piscine and poultry groups.

In some examples, the cell is a muscle cell, muscle stem cells or extract thereof. In some examples, the muscle cells or muscle stem cells are chicken cells.

Notably, cells can also be a source for other components, such as lipids. For example, the edible film can comprise adipocytes as a source for fat.

In some examples, the adipocytes are piscine derived adipocytes.

In some examples, the adipocytes are porcine derived adipocytes.

In some examples, the adipocytes are chicken adipocytes.

Edible microbial biomass derived from bacteria, yeasts, filamentous fungi or microalgae is a promising alternative to conventional sources of food and feed. Thus, in some examples, the plant-based edible hydrogel film comprises microorganisms, mostly but not exclusively as a protein source. The microorganisms are those which are safe for human consumption.

In some examples, the film comprises microalgae. In some examples, the algae is spirulina. In some examples, the algae are chlorella. In some examples, the algae is tetraselmis. In some examples, the algae is isochrysis. In some examples, the algae is a combination of different types of algae, such as those exemplified above.

In some examples, the film comprises yeast, typically yeast extract.

The yeast can be from different sources, e.g. brewer's yeast (Saccharomyces cerevisiae, typically used for beer brewing or backing).

The protein within the hydrogel film can also comprise recombinantly produced protein. There are well known techniques for producing recombinant proteins. This typically includes production of mammalian proteins in plant cells or microorganism systems (e.g. yeast), using genetically engineered expression vectors.

In some examples, the edible hydrogel film comprises recombinantly produced whey protein and/or lactoglobulin and/or casein. Such film would preferably be used for the production of dairy alternative products. Other recombinantly produced ingredients can include, without being limited thereto, gelatin, hemoglobin, collagen, albumin etc.

The plant based edible hydrogel film of the present disclosure can also comprise edible emulsifiers. The purpose of the emulsifier is to allow the formation of a physically stable emulsion which is essential for the formation of the film composition. As appreciated, emulsion gel is a composite structure consisting of oil droplets within a gel matrix. As further described hereinbelow, the blend forming the hydrogel film is an emulsion gel.

In some examples, the emulsifier comprises lecithin or lecithin alternative. The lecithin can be of various sources, including, without being limited thereto, soy lecithin and sunflower lecithin. In some examples, the lecithin is sunflower lecithin.

In some examples, the emulsifier comprises lecithin alternatives such as, without being limited thereto, polyglycerol polyricinoleate, ammonium phosphatide (AMP), mono and diglycerides, poloxamers, phospholipids, pegylated aliphatic alcohols, pegylated fatty acids, lecithin, polyglycerol esters (PGE), polysorbates, stearoyl lactylates, propylene glycol esters (PGMS), sucrose esters, polyglycerol polyricinoleate (PGPR), Ammonium phosphatide (AMP).

The plant-based edible hydrogel film also comprises lipids. In the context of the present disclosure the term lipid encompasses fats and oils.

In some examples, the lipid comprises plant derived oil. There are different plant derived oils that are acceptable in the food industry. The selection of the oil to be used can be based on the physical state at room temperature, e.g. solid, semi solid, liquid, on the organoleptic properties of the oil, and other considerations.

The lipid can be any one of combination of short-chain triglycerides, medium-chain triglycerides, long-chain triglycerides, sunflower oil, corn oil, palm oil, olive oil, canola oil, coconut oil, avocado oil, sesame oil, hydrogenated castor oil, hydrogenated castor oil derivatives, polyethylene glycols, citrate esters, phthalate esters, glyceryl esters, triacetin, glyceryl stearate, glyceryl behenate, dibutyl sebacate, aliphatic alcohols, fatty acids, sorbitan derivatives.

In some examples, the plant derived oil is selected from the group consisting of canola oil, coconut oil, corn oil, olive oil, sunflower oil, soybean oil, sesame oil, and any derivatives and combination of same.

In some examples, the plant derived oil comprises or is canola oil.

In some examples, the plant derived oil comprises or is coconut oil.

In some examples, the plant derived oil comprises a combination of at least canola oil and coconut oil. In some examples, when containing canola oil and coconut oil, the ratio between the two is essentially 1:1±10%.

In some examples, the lipid comprises triglycerides, typically medium chain triglycerides (MCT). When referring to MCT it is to be understood to encompass 6-12 carbon fatty acids and can include any one or combination of caprylic acid and capric acid. MCT can be obtained from plant, e.g. coconut oil, palm kernel oils or can be man mad or partially man mad. In the context of the present disclosure, any type of animal free MCT can be used.

In some examples, the plant-based edible hydrogel film disclosed herein comprises a filler. Edible fillers are widely used in the food industry, with the aim of helping bulk up the weight of the food. Food fillers are commonly used in meat and meat alternatives.

In some examples, the food filler is any filler known to be used in the meat or meat alternative industry. This may include, without being limited thereto, starch, such as potato starch and/or tapioca starch.

In some examples, the food filler comprises food grade calcium carbonate.

In some examples, the food filler comprises mannitol; hydrogenated starch hydrolysates, sorbitol, sucrose, maltitol, isomalt, lactitol, maltitol, sorbitol, xylitol, erythritol and any combinations of same.

In some examples, the plant-based edible hydrogel film comprises fibers. When referring to fibers it is to be understood to encompass plant-derived fibers such as, without being limited thereto, citrus fibers, inulin.

The plant-based edible hydrogel film comprises water, held by the hydrogel matrix. The water content can be determined by simple weighting the film before and after complete dehydration. In some examples, the water content in the hydrogel film comprises between about 20% v/v and 90% v/v water. In some examples, the film comprises between about 25% v/v and 70% v/v; at times, between 30% v/v and 80% v/v; at times between 25% v/v and 75% v/v; at times any range between 20% v/v and 90% v/v.

The plant-based edible hydrogel film can comprise other edible additives, such as, without being limited thereto, fibers, colorants, acidulants, flavoring agents or flavoring enhancing agents, antioxidants, dietary fortifying agents, preservatives, stabilizers, sweeteners, thickeners, vitamins and minerals

The hydrogel film can have different shapes, including a geometrical shape or an amorphous shape as well as different dimensions.

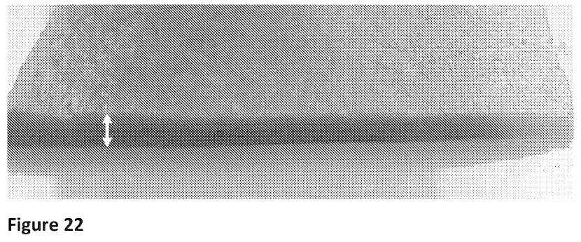

As detailed herein and shown in FIG. 22, the hydrogel film is characterized by having a height of up to about 8 mm, at times even up to about 6 mm, and even up to about 4 mm and as further exemplified herein below.

It should be noted that the height of the film is selected in order to obtain a continuous film structure.

It should be further noted that a film coating method is suitable for the preparation of films which various heights, including in nanometer scale, micrometer scale and millimeter scale.

In some examples, the hydrogel film has a contour of a polygon. In some embodiments, the hydrogel film has at least one of a square contour or a rectangular contour.

In some examples, the hydrogel film provided that at least one of its dimensions, being the height, is less than about 8 mm, at times less than about 7 mm, at times less than about 4 mm, at times less than about 3 mm.

In some embodiments, at least one of the film dimensions (height (thickness), diameter) is up to about 4 mm, up to about 3 mm, up to about 2 mm, up to about 1 mm.

In some embodiments, at least one of the film dimensions (height, diameter) is between about 1 nn and about 4 mm, at times about 5 nn and about 4 mm, at times about 10 nn and about 4 mm, at times about 100 nn and about 4 mm, at times about 1 mm and about 4 mm.

In some embodiments, at least one of the film dimensions (height, diameter) is between about 1 nn and about 4 mm, at times about 1 nn and about 3 mm, at times about 1 nn and about 2 mm, at times about 1 nn and about 1 mm.

In some embodiments, at least one of the film dimensions is of about 1 nm, about 2 nm, up to about 4 mm, up to about 3 mm, up to about 2 mm, up to about 1 mm.

The hydrogel film can be in a form of a sheet or strip.

In some examples, the film is a sheet having square contour.

In some examples, the film is a strip having a rectangular contour.

In some examples, the hydrogel film has a contour that includes a curve.

In some embodiments, the hydrogel film has at least one of a circular contour or an elliptical contour.

In some examples, at least one dimension of the film (e.g. sheet, strip) is less than 5 mm; at times, less than 4 mm; at times, less than 3 mm; at times, less than 2 mm; at times less than 1 mm.

In some examples, the cross-section of the film is essentially circular

In some other examples, cross section of the film has an elliptical shape.

In some examples, the film is in a form of a thread.

In some examples, the film is in a form of a thread having a circular cross section.

In some examples, the film is in a form of a thread having a non-circular cross section.

In some examples, the thread having an elliptical cross section.

In some examples, each one of the two diameters in an elliptical cross section are at times less than about 5 mm.

In some examples, the thread having has a diameter of less than 5 mm, at times less than 3 mm, at times less than 1 mm.

In some examples, the thread having a diameter of between about mm and about 4 mm, at times between about 1 mm and about 4 mm, at times between about 1 mm and about 3 mm.

In some embodiments, the thread having a diameter of up to about 4 mm, up to about 3 mm, up to about 2 mm, up to about 1 mm.

In some embodiments, the thread having a diameter of between about 1 nn and about 4 mm, at times about 5 nn and about 4 mm, at times about 10 nn and about 4 mm, at times about 100 nn and about 4 mm, at times about 1 mm and about 4 mm.

In some embodiments, the thread having a diameter of between about 1 nn and about 4 mm, at times about 1 nn and about 3 mm, at times about 1 nn and about 2 mm, at times about 1 nn and about 1 mm.

In some embodiments, the thread having a diameter of about 1 nm, about 2 nm, up to about 4 mm, up to about 3 mm, up to about 2 mm, up to about 1 mm.

The film can be characterized by its disintegration rate. The disintegration rate can be determined as the time of visual disintegration once a sample of the film, e.g. having dimensions of 1 cm² area is stirred by a magnetic stirrer, within a pre-heated water (100 ml, 37° C.) and the time until essentially complete visual disintegration is observed. In some examples, when placing a sample of the film with the above prescribed dimensions, within the water, the film has a disintegration rate of more than 3 minute; at times more than 4 minutes; at times more than 5 minutes; at times, more than 10 minutes; at times more than 20 minutes; at times, more than 25 minutes.

The disclosed plant-based food product can be used as part of a ready to eat food product. The ready to eat food product can include a single film or can be composed of two or more films (optionally in combination with other ingredients).

Thus, the present disclosure also provides a plant-based food product comprising at least one plant-based edible hydrogel film as disclosed and defined herein.

In some examples, the food product comprises one or more films that are folded, bundled or in rolled configuration. In some examples, the food product comprises one or more films, e.g. sheets, strips or threads that are folded, bundled or in rolled configuration. When folded, the folding of the film can be in a zig-zag (accordion) configuration. When rolled, the film can be spirally wound. When comprising more than one film, the films can be the same or different within a single food product.

In some examples, the food product comprises more than one film, which can be the same or different, in stacked form, one film being on top of another.

The two or more films within a food product are at least partially adhered to its neighboring film (i.e. adherence at the films' facing surfaces). In some examples, neighboring films are adhered one to each other to an extent that the boundaries between the films cannot be detected by visual inspection but could at least partially be identified when using magnification devices.

The plant-based food product comprising a single, two or more hydrogel films disclosed herein, which can be the same or different, can be constructed to constitute a meat analogue or a dairy analogue. The specific selection of hydrogel films will determine the fate of the product in terms of rheological properties and/or organoleptic properties and consequently, its commercial characteristics, for example, if it is considered a meat analogue, a dairy analogue or possible a new food.

In some examples, the food product is a dairy analogue. In some examples, the food product is a cheese analogue.

In some other examples, the food product is a meat analogue.

In some examples, the plant-based food product disclosed herein is a plant-based chicken meat analogue.

In some examples, the plant-based food product disclosed herein is a plant-based chicken seafood analogue, e.g. fish analogue.

In some examples, the plant-based food product is a pasta.

In some examples, the chicken meat analogue product disclosed herein comprises at least two plant-based edible hydrogel films, each film, which can be the same or different, comprise a homogenous blend of hydrocolloid forming polymers, a protein, a lipid and water; wherein the hydrocolloid forming polymers comprise at least two viscosity increasing polymers, each viscosity increasing polymer having a viscosity of at least 4,000 cP at 25° C., when dissolved in water, at a concentration of about 2% (w/v); and the at least two viscosity increasing polymers comprise MC and HPMC in a total/overall amount of between about 10 wt % and about 10.5 wt % out of the total dry weight of the meat analogue. In some examples, the chicken meat analogue product disclosed herein comprises hydrocolloid forming polymer in a combined amount of between about 11.8 wt % and about 12.1 wt % out of the total dry weight of the meat analogue.

In one particular example of the plant-based chicken meat analogue comprises as hydrocolloid forming polymer HPMC and MC, the MC is preferably one known to have a viscosity of about 4,000 cP at 25° C. and the HPMC is preferably one known to have a viscosity of about 15,000 cP, both viscosities being determined when these types of polymers are dissolved in water at a concentration of about 2% (w/v), at the viscosities are measured at 25° C.

The plant-based chicken meat analogue comprising as hydrocolloid forming polymer HPMC and MC can also comprise within the films from which it is formed, maltodextrin, lecithin, canola oil and chickpea and/or pea protein.

In one preferred example of the plant-based chicken meat analogue comprising as hydrocolloid forming polymers HPMC and MC, the meat analogue further comprises maltodextrin in an amount of about 5.7 wt %, sunflower lecithin in an amount of about 6.7 wt %, medium chain triglyceride (MCT) in an amount of about 16.2 wt %, canola oil in an amount of about 16.7 wt %, pea protein in an amount of about 13.3 wt %, chickpea protein in an amount of about 8.3 wt %, salt in an amount of about 3.3 wt %, citrus fibers in an amount of about 4 wt %, mannitol in an amount of about 5.3 wt % and flavoring and colorants, each amount being out of the total dry weight of the food product.

In one specific example, the plant-based chicken meat analogue product comprises the components of Example 1, which form an integral part of the present disclosure.

In one other specific example, the plant-based chicken meat analogue product comprises the components of Example 2, which forms part of the present disclosure.

In some other examples, the plant-based chicken meat analogue product comprises at least two hydrogel films, each film, which can be the same or different, comprise a homogenous blend of hydrocolloid forming polymers, a protein, a lipid and water as defined herein, wherein the hydrocolloid forming polymer comprises at least two viscosity increasing polymers, the at least two viscosity increasing polymers being in a combined amount of between about 7.1 wt % and about 7.3 wt % out of the total dry weight of the food product; and the two viscosity increasing polymers comprise or consist essentially of HPMC (viscosity of about 15,000 cP at 25° C., when dissolved in water, at a concentration of about 2% (w/v)) and MC (viscosity of about 4,000 cP at 25° C., when dissolved in water, at a concentration of about 2% (w/v)).

In this particular example of the plant based chicken meat analogue, the HPMC and MC is combined with maltodextrin in an amount of about 4.2 wt %, sunflower lecithin in an amount of about 5.5 wt %, canola oil in an amount of about 23.3 wt %, pea protein in an amount of about 11.7 wt %, chickpea protein in an amount of about 20.0 wt %, salt in an amount of about 1.7 wt %, citrus fibers in an amount of about 7.3 wt %, mannitol in an amount of about 8.3 wt % and flavoring and colorants, each amount being out of the total dry weight of the food product.

A further specific plant-based chicken analogue product disclosed herein comprises the components of Examples 6 and 7, each independently forming part of the present disclosure.

Also disclosed herein, in accordance with some other examples, a plant-based chicken meat analogue product comprising at least two plant-based edible hydrogel films, each film, which can be the same or different, comprise a homogenous blend of a hydrocolloid forming polymer, a protein, a lipid and water; wherein the viscosity increasing polymers comprise HPMC and MC in a total amount of between about 8.6 wt % and about 8.8 wt % out of the total dry weight of the chicken meat analogue product. The HPMC and MC preferably comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v). In some embodiments, plant-based chicken meat analogue product comprising hydrocolloid forming polymers in an amount of between about 9.4 wt % and about 9.6 wt % out of the total dry weight of the food product.

In a particular example of the above chicken meat analogue, the HPMC and MC (being in a total amount of between about 8.6 wt % and about 8.8 wt %) are combined with maltodextrin in an amount of about 5.3 wt %, sunflower lecithin in an amount of about 6.7 wt %, canola oil in an amount of about 30.5 wt %, chicken muscle cell in an amount of about 11.5 wt %, salt in an amount of about 3.3 wt %, citrus fibers in an amount of about 4.2 wt %, mannitol in an amount of about 10.7 wt % and flavoring and colorants, each amount being out of the total dry weight of the chicken analogue.

In another particular example of the above chicken meat analogue, the HPMC and MC in the recited ranges, are combined with maltodextrin in an amount of about 5.3 wt %, sunflower lecithin in an amount of about 6.7 wt %, canola oil in an amount of about 30.5 wt %, fish adipocyte cells in an amount of about 18.3 wt %, salt in an amount of about 3.3 wt %, citrus fibers in an amount of about 4.0 wt %, mannitol in an amount of about 13.7 wt % and flavoring and colorants, each amount being out of the total dry weight of the chicken analogue.

A further specific plant-based chicken analogue product disclosed herein comprises the components of Example 9, which forms an independent part of the present disclosure.

A further specific plant-based chicken analogue product disclosed herein comprises the components of Example 13, which forms an independent part of the present disclosure.

Also disclosed herein is a plant-based ham analogue product. The plant based ham analogue comprises, in accordance with some examples, at least two plant-based hydrogel films, each film, which can be the same or different, comprise a homogenous blend of a hydrocolloid forming polymer, a protein, a lipid and water; wherein the hydrocolloid forming polymers comprise at least two viscosity increasing polymers, each viscosity increasing hydrocolloid forming polymers having a viscosity of at least 4,000 cP at 25° C., when dissolved in water, at a concentration of about 2% (w/v); and the at least two viscosity increasing polymers comprise MC and HPMC in a total amount of between about 11.2 wt % and about 11.6 wt % out of the total dry weight of the ham analogue product. In some embodiments, the hydrocolloid forming polymers are in a total amount of between about 14.0 wt % and about 14.3 wt % out of the total dry weight of the ham analogue product.

In some examples, the MC and HPMC in the ham analogue comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

A particular, yet non-limiting example, of the ham analogue disclosed herein, comprises, in addition to the HPMC and MC, maltodextrin in an amount of about 5.2 wt %, sunflower lecithin in an amount of about 8.3 wt %, medium chain triglyceride (MCT) in an amount of about 16.7 wt %, canola oil in an amount of about 17.3 wt %, pea protein in an amount of about 10.0 wt %, chickpea protein in an amount of about 10.0 wt %, salt in an amount of about 1.8 wt %, citrus fibers in an amount of about 3.3 wt %, mannitol in an amount of about 5.3 wt % and flavoring and colorants, each amount being out of the total dry weight of the plant based ham analogue.

A specific plant-based ham analogue product disclosed herein comprises the components of Example 3 which forms part of the present disclosure.

In some examples, the plant-based food analogue is a bacon analogue product comprising at least two plant-based edible hydrogel films, each film, which can be the same or different, comprise a homogenous blend of hydrocolloid forming polymers, a protein, a lipid and water; wherein the hydrocolloid forming proteins comprise at least two viscosity increasing hydrocolloid forming polymers, each of the viscosity increasing polymers having a viscosity of at least 4,000 cP at 25° C., when dissolved in water, at a concentration of about 2% (w/v); the at least two viscosity increasing hydrocolloid forming polymers comprise HPMC and MC in a total amount of between about 11.2 wt % and about 11.4 wt % out of the total dry weight of the bacon analogue product. In some embodiments, the hydrocolloid forming polymers are in an amount of between about 14.2 wt % and about 14.4 wt % out of the total dry weight of the bacon analogue product.

In some particular examples of the plant-based bacon analogue product the at least two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

In yet some particular examples of the plant-based bacon analogue product disclosed herein, at least some films comprise maltodextrin in an amount of about 4.2 wt %, sunflower lecithin in an amount of about 8.0 wt %, medium chain triglyceride (MCT) in an amount of about 16.7 wt %, canola oil in an amount of about 16.7 wt %, pea protein in an amount of about 10.0 wt %, chickpea protein in an amount of about 10.0 wt %, salt in an amount of about 2.3 wt %, citrus fibers in an amount of about 3.7 wt %, mannitol in an amount of between about 3.2 wt % and about 4.8 wt % and flavoring and colorants, each amount being out of the total dry weight of the bacon analogue product.

A specific plant-based bacon analogue product disclosed herein comprises the components of Example 4, which forms part of the present disclosure.

Also provided herein, in accordance with some examples, is a plant-based cheese analogue product comprising at least two plant-based edible hydrogel films, each edible hydrogel film, which can be the same or different, comprise a homogenous blend of hydrocolloid forming polymers, a protein, a lipid and water; wherein the hydrocolloid forming polymers comprise at least one viscosity increasing polymer having a viscosity of at least 4,000 cP at 25° C., when dissolved in water, at a concentration of about 2% (w/v); the at least one viscosity increasing polymers being in a total amount of about 3.0 wt % out of the total dry weight of the cheese analogue product; and the at least one viscosity increasing polymer comprise MC. In some embodiments, the hydrocolloid forming polymers are in a combined total amount of about 6 wt %.

In some particular examples of the cheese analogue product, the at least one viscosity increasing polymer comprises or consists essentially of MC having a viscosity of about 4,000 cP at 25° C., when dissolved in water, at a concentration of about 2% (w/v).

In some further particular examples, the plant based cheese analogue product further comprises maltodextrin in an amount of about 3.0 wt %, sunflower lecithin in an amount of about 9.0 wt %, medium chain triglyceride (MCT) in an amount of about 16.7 wt %, canola oil in an amount of about 17.9 wt %, coconut oil in an amount of about 27 wt %, chickpea protein in an amount of about 4.5 wt %, whey protein in an amount of about 6.7 wt %, casein protein in an amount of about 6.7 wt %, salt in an amount of about 1.5 wt %, mannitol in an amount of about 7.5 wt %, calcium carbonate in an amount of about 4.5 wt %, yeast extract in an amount of about 5.2 wt % and flavoring and colorants, each amount being out of the total dry weight of the cheese analogue product.

One specific example of the cheese analogue product comprises the components of Example 8, independently forming part of the present disclosure.

The present disclosure also provides a plant-based salmon flash analogue product comprising at least two hydrogel films, each layer, which can be the same or different, comprise a homogenous blend of hydrocolloid forming polymers, a protein, a lipid and water; wherein the hydrocolloid forming polymers comprise at least two viscosity increasing polymers, each viscosity increasing hydrocolloid forming polymers having a viscosity of at least 4,000 cP at 25° C., when dissolved in water, at a concentration of about 2% (w/v); and the at least two viscosity increasing polymers comprise HPMC and MC in a total amount of about 8.7 wt % out of the total dry weight of the salmon meat analogue product. In some embodiments, the plant-based salmon flash analogue product comprising hydrocolloid forming polymers in an amount of about 9.5 wt % out of the total dry weight of the salmon meat analogue.

In some examples of the plant-based salmon meat analogue product the at least two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v).

In one particular example, the plant-based salmon disclosed herein comprises the components of Example 10, independently forming part of the present disclosure.

In one particular example, the plant-based salmon disclosed herein comprises the components of Example 17, independently forming part of the present disclosure.

Further provided herein, in accordance with some examples, a plant-based yellow cheese analogue product comprising at least two plant-based edible hydrogel films, each film, which can be the same or different, comprise a homogenous blend of hydrocolloid forming polymers, a protein, a lipid and water; wherein the hydrocolloid forming polymers comprise at least two viscosity increasing hydrocolloid forming polymers, each viscosity increasing hydrocolloid forming polymers having a viscosity of at least 1,000 cP at 25° C., when dissolved in water, at a concentration of about 2% (w/v);
said at least two viscosity increasing polymers comprises xanthan gum and guar gum in a total amount of about 14.9 wt % out of the total dry weight of the yellow cheese analogue product.

In some particular examples of the disclosed yellow cheese, at least some of the films also comprise sunflower lecithin in an amount of about 10.4 wt %, canola oil in an amount of about 20.9 wt %, coconut oil in an amount of about 20.9, pea protein in an amount of about 6 wt %, chickpea protein in an amount of about 17.9 wt %, salt in an amount of about 1.8 wt %, mannitol in an amount of about 3.0 wt %, yeast extract in an amount of about 1.2 wt % and flavoring and colorants, each amount being out of the total dry weight of the yellow cheese analogue.

In one particular example, the plant-based yellow cheese disclosed herein comprises the components of Example 11, independently forming part of the present disclosure.

Further disclosed herein is a plant-based hard cheese analogue product comprising at least two plant-based edible hydrogel films, each film, which can be the same or different, comprise a homogenous blend of at least one hydrocolloid forming polymer, a protein, a lipid and water; wherein the at least one hydrocolloid forming polymer comprises at least one viscosity increasing polymer having a viscosity of at least 1,500 cP at 25° C., when dissolved in water, at a concentration of about 2% (w/v); the at least one viscosity increasing polymer comprises CMC in an amount of about 3.0 wt % out of the total dry weight of the hard cheese analogue product; and the homogenous blend comprises starch in an amount of about 11.9 wt %.

In some particular examples, the hard cheese comprises also sunflower lecithin in an amount of about 7.5 wt %, canola oil in an amount of about 16.4 wt %, coconut oil in an amount of about 16.4, pea protein in an amount of about 6.0 wt %, chickpea protein in an amount of about 17.9 wt %, salt in an amount of about 1.5 wt %, mannitol in an amount of about 11.5 wt %, yeast extract in an amount of about 3.0 wt % and flavoring and colorants, each amount being out of the total dry weight of the food product.

In one particular example, the plant-based hard cheese disclosed herein comprises the components of Example 12, independently forming part of the present disclosure.

In some examples, the plant-based chicken meat analogue product disclosed herein is prepared from the emulsion composition shown in Table 1A, independently forming part of the present disclosure. In some examples, the plant-based chicken meat analogue product disclosed herein is prepared from the emulsion composition of Table 1A using a method described in Examples 13 or 14.

In some examples, the plant-based chicken meat analogue product disclosed herein is prepared from the emulsion composition shown in Table 5A or Table 5B, independently forming part of the present disclosure. In some examples, the plant-based chicken meat analogue product disclosed herein prepared from the emulsion composition of Table 5A or Table 5B using a method described in Examples 13 or 14.

In some examples, the plant-based chicken analogue product disclosed herein is prepared from the emulsion composition shown in Table 8A, which forms an independent part of the present disclosure. In some examples, the plant-based chicken meat analogue product disclosed herein prepared from the emulsion composition of Table 8A using a method described in Examples 13 or 14.

In some examples, the plant-based ham analogue product disclosed herein is prepared from the emulsion composition shown in Table 2A which forms part of the present disclosure. In some examples, the plant-based ham analogue product disclosed herein prepared from the emulsion composition of Table 2A using a method described in Examples 13 or 14.

In some examples, the plant-based bacon analogue product disclosed herein is prepared from the emulsion composition shown in Table 3A, which forms part of the present disclosure. In some examples, the plant-based bacon analogue product disclosed herein prepared from the emulsion composition of Table 3A using a method described in Examples 13 or 14.

In some examples, the plant-based cheese analogue product disclosed herein is prepared from the emulsion composition shown in Table 7A, which forms part of the present disclosure. In some examples, the plant-based cheese analogue product disclosed herein prepared from the emulsion composition of Table 7A using a method described in Examples 13 or 14.

In some examples, the plant-based salmon analogue product disclosed herein is prepared from the emulsion composition shown in Table 9A, which forms part of the present disclosure. In some examples, the plant-based salmon analogue product disclosed herein prepared from the emulsion composition of Table 9A using a method described in Examples 13 or 14.

In some examples, the plant-based salmon analogue product disclosed herein is prepared from the emulsion composition shown in Table 15A, which forms part of the present disclosure. In some examples, the plant-based salmon analogue product disclosed herein prepared from the emulsion composition of Table 15A using a method described in Example 17.

In some examples, the plant-based yellow cheese disclosed herein is prepared from the emulsion composition shown in Table 10A, which forms part of the present disclosure. In some examples, the plant-based yellow cheese disclosed herein prepared from the emulsion composition of Table 10A using a method described in Examples 13 or 14.

In some examples, the plant-based hard cheese disclosed herein is prepared from the emulsion composition shown in Table 11A, which forms part of the present disclosure. In some examples, the plant-based hard cheese disclosed herein prepared from the emulsion composition of Table 11A using a method described in Examples 13 or 14.

A unique feature of the plant-based food products disclosed herein, which is essentially common to all types and variations of the disclosed food product, relates to the products' disintegration time.

The present disclosure also provides a method for forming the plant-based edible hydrogel film disclosed herein.

The method comprises at least
providing of an emulsion composition comprising a homogenous blend of at least one hydrocolloid forming polymer, a protein, a lipid and water, wherein the hydrocolloid forming polymers comprise one or more viscosity increasing polymers, each viscosity increasing polymer having a viscosity of at least 1,000 cP at 25° C., when dissolved in water, at a concentration of about 2% (w/v); the one or more viscosity increasing polymers being in a total amount of between 2 wt % and 20 wt % out of the total dry weight of the blend;
forming a film from said emulsion composition; and
at least partially drying the film to obtain said plant-based edible hydrogel film.

In some examples, the method comprises forming the film by spreading a mass of the emulsion composition onto a film forming bed or within a mold.

In some examples the method comprises controlling thickness of the film.

In some examples, the control of thickness is by using a film forming gap applicator. There are various types of film forming gap applicators in the art, each being defined, inter alia, by the thickness of the film they can produce.

In some examples, the gap applicator is used to provide a film with a thickness of between about 250 μm and about 5,000 μm; at times, between about 250 μm and about 4,000 μm; at times between about 250 μm and about 3,000 μm; at times between about 500 μm and about 2,500 μm; at times between about 250 μm and about 1,000 μm; at times between about 250 μm and about 500 μm.

In some examples, the method comprises forming the film in a form of a thread by pressing a mass of the emulsion composition through nozzles. In some examples, the method comprises forming the film in a form of a strip by pressing a mass of the emulsion composition within a mold.

In some examples, the method comprises at least partially drying of the film by exposing the film to a controlled heat. The at least partially drying of the film can be by any one or combination of heating the film within an oven, exposing the film to drying air, exposing the film to infrared (IR) radiation or heating within a microwave.

In some examples, the at least partially drying of the film is until water content within the film is between 20% and 90%, at times between 25% and 70%; at times between 40% and 70%; at times between 50% and 70%.

The method disclosed herein provides a hydrogel film as defined herein.

Also disclosed herein is a method of producing a plant-based food product, the method comprises
(i) providing one or more emulsion compositions comprising a homogenous blend of at least one hydrocolloid forming polymers, a protein, a lipid and water; wherein the hydrocolloid forming polymer comprises one or more viscosity increasing polymers, each viscosity increasing polymers having a viscosity of at least 1,000 cP at 25° C., when dissolved in water, at a concentration of about 2% (w/v); and the one or more viscosity increasing polymers being in a total amount of between 2 wt % and 20 wt % out of the total dry weight of the food product;
(ii) forming a first film from one of the emulsion compositions;
(iii) placing on the first film at least one additional film;
wherein each film can be the same or different from a previously placed film; and
wherein each additional film is formed on a previously applied film after said previously applied film is at least partially dried.

The method of forming the food product comprises, in accordance with some examples, the stacking of a plurality of films one on top of another, the plurality of films can be the same or different with the same product.

In some examples, at least part of the plurality of films are formed prior to being stacked one on top of another.

In some further examples, at least part of the films are formed by spreading the emulsion composition onto a film forming bed or within a mold to form a film with a defined thickness (height) and at least partially drying the thus formed film.

The method of forming the food product comprises, in accordance with some examples, cooling multiple film layers obtained after placing on the first film at least one additional film.

A further alternative method disclosed herein for producing a plant-based food product comprises
(i) providing one or more emulsion compositions comprising a homogenous blend of at least one hydrocolloid forming polymer, a protein, a lipid and water; wherein
   said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
   said one or more viscosity increasing polymers being in a total amount of between 2 wt % and 20 wt % out of the total dry weight of the food product;
(ii) forming a first film from one of the emulsion compositions;
(iii) placing on said first film at least one additional film to form a multiple layered film;
wherein each film can be the same or different from a previously placed film;
wherein each additional film is formed on a previously applied film after the previously applied film is at least partially dried; and
(iv) reducing the temperature of the multiple layered film.

In some embodiments, the method comprises reducing the temperature to a temperature of at most 10° C.

In some embodiments, the method comprises cooling the multiple layered film to a temperature of between about 2° C. and about 10° C., at times between about 4° C. and about 8° C.

In some embodiments, the method comprises drying the film. The drying conditions are selected to allow formation of a continuous film.

In some embodiments, the drying is at a temperature of at least about 60° C., at least about 70° C., at least about 80° C., at least about 90° C.

In some embodiments, the drying is at a temperature of between about 60° C. and about 100° C., at times between about 70° C., and about 100° C.

In some embodiments, the drying is at a temperature of about 60° C., about 65° C., about 70° C., about 80° C., about 90° C., about 95° C.

In some embodiments, the drying is for at least about 5 minutes, at least about 10 minutes, at least about 15 minutes, at least about 20 minutes, at least about 25 minutes, at least about 30 minutes.

In some embodiments, the drying is for about 5 minutes, about 10 minutes, about 15 minutes, about 20 minutes, about 25 minutes, about 30 minutes, about 35 minutes, about 40 minutes.

In some examples, the drying is at a temperature of about 65° C. for about 30 minutes.

In some examples, the drying is at a temperature of about 70° C. for about 30 seconds, at times for about 40 seconds, at times for about 50 seconds, at times for about 60 seconds, at times for about 70 seconds, at times for about 80 seconds, at times for about 90 seconds, at times for about 100 seconds, at times for about 120 seconds.

In some examples, the drying is at a temperature of about 70° C. for about 5 minutes, at times for about 20 minutes, at time for about 25 minutes, at times for about 30 minutes, at times for about 50 minutes.

It was suggested by the inventors that the at least one hydrocolloid forming polymer comprises at least one polymer having a dissolution behavior that is favored by a decrease in temperature. Without being bound by theory, it was suggested by the inventors that reducing the temperature improves the adhesion of multiple films, e.g. strip and/or thread.

A further alternative method disclosed herein for producing a plant-based food product comprises
(i) providing an emulsion composition comprising a homogenous blend of at least one hydrocolloid forming polymer, a protein, a lipid and water; wherein the at least one hydrocolloid forming polymer comprises one or more viscosity increasing polymers, each viscosity increasing polymers having a viscosity of at least 1,000 cP at 25° C., when dissolved in water, at a concentration of about 2% (w/v); the one or more viscosity increasing polymers being in a total amount of between 2 wt % and 20 wt % out of the total dry weight of the food product;
(ii) folding the hydrogel film into a folded film; and
(iii) at least partially drying the folded film to obtain the plant-based food product.

The methods disclosed herein for producing the food product commonly comprise, in accordance with some examples, at least partially drying is by any one or combination of heating within an oven, exposing to drying air, exposing to IR radiation or heating within a microwave.

Further, the methods disclosed herein for producing the food product commonly comprise, in accordance with some examples, controlling thickness (height) of each film; the control being in a manner described herein.

As used herein, the forms “a”, “an” and “the” include singular as well as plural references unless the context clearly dictates otherwise. For example, the term “a polymer” or “a protein” includes one or more polymers or proteins, respectively, which can form part of the hydrogel film.

Further, as used herein, the term “comprising” is intended to mean that the composition include the recited components, e.g. hydrocolloid forming polymers, protein, lipids, water but not excluding other components, such as flavoring agents, colorants, etc. The term “consisting essentially of” is used to define films of products which include the recited components but exclude other components that may have an essential significance on the organoleptic and/or rheological properties of the film or product containing the same. “Consisting of” shall thus mean excluding more than trace amounts of other components. Embodiments defined by each of these transition terms are within the scope of this invention.

Further, all numerical values, e.g. when referring the amounts or ranges of the components constituting the film or food product, are approximations which are varied (+) or (−) by up to 20%, at times by up to 10% of from the stated values. It is to be understood, even if not always explicitly stated that all numerical designations are preceded by the term “about”.

It should be noted that various embodiments of this invention may be presented in a range format. The description of a range should be considered to have specifically disclosed all the possible sub ranges as well as individual numerical values within that range. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

It should be further noted that the various embodiments and examples detailed herein in connection with various aspects of the invention may be applicable to one or more aspects disclosed herein. It should be further noted that any embodiment described herein, for example, related to components of the food ingredient, may be applied separately or in various combinations. Various embodiments and aspects of the present invention as delineated hereinabove and as claimed in the claims section below find experimental support in the following examples. The phrases “in another embodiment” or any reference made to embodiment as used herein do not necessarily refer to different embodiment, although it may. Thus, various embodiments of the invention can be combined (from the same or from different aspects) without departing from the scope of the invention.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### SOME NON-LIMITING EXAMPLES

### Materials

Table 1 provides the materials used in the following non-limiting examples, their potential functionality and their viscosity at a defined concentration.

TABLE 1
Materials

| | | Viscosity (cP) |
|---|---|---|
| Material | Functionality | at % w/v |
| Maltodextrin 15DE | hydrocolloid forming | 125 at 50% |
| | polymer (film former) | |
| Hydroxypropylcellulose GF | hydrocolloid forming | 150-400 at 2% |
| | polymer film former) | |
| Methylcellulose A4M | hydrocolloid forming | 4000 at 2% |
| | polymer (film former) | |
| Hydroxypropyl | hydrocolloid forming | 15000 at 2% |
| Methylcellulose K15M | polymer (film former) | |
| Xanthan gum | hydrocolloid forming | 1000-2000 at 1% |
| | polymer (film former) | |
| Guar gum | hydrocolloid forming | 3000-5000 at 1% |
| | polymer (film former) | |
| Carboxymethyl | hydrocolloid forming | 1500-3000 at 1% |
| cellulose - Sodium Salt | polymer (film former) | |
| Starch | Filler/hydrocolloid | NA |
| | forming polymer | |
| Sunflower Lecithin | Emulsifier | |
| Medium Chain | Fat | |
| Triglyceride (MCT) | | |
| Canola oil | Fat | |
| Coconut oil | Fat | |
| Pea protein | Protein | |
| Chickpea protein | Protein | |
| Soy protein TVP (Textured | Protein | |
| Vegetable Protein) | | |
| Chicken muscle cell | Cultured meat | |
| | component | |
| Fish adipocyte | Cultured fish | |
| | component | |
| Whey protein | Recombinant Protein | |
| Casein | Recombinant Protein | |
| Salt | Taste | |
| Flavoring & Coloring | Taste | |
| Citrus Fibers | Texturizing | |
| | agent/hydrocolloid | |
| | forming polymer | |
| Mannitol | Filler | |
| Calcium carbonate | Filler | |
| Yeast extract | Taste | |

### Methods

Viscosity [cP]

Viscosity was determined using a standard viscosimeter VIS-8 (MRC).

### Moisture Content (%)

For determination of moisture content in the different products, a Moisture Analyzer MA35 (Sartorius) was used. This MA uses a thermogravimetric procedure for determining moisture content of a tested sample. Each sample weighted 2-4 gr. The analysis was conducted at 115° C. with a drying time of 20-30 minutes. Interval for automatic intermediate results was 1.5 minute.

### Disintegration Time

For determining disintegration time, preheated (37° C.) water (100 ml) was poured into a glass beaker equipped with a magnetic stirrer (ARE Heating Magnetic Stirrer). The water temperature was maintained at around 37° C. while being continuously mixed by the magnetic stirrer. A sample of 1 cm*1 cm*thickness (of final product) was then inserted into the heated water and time to complete disintegration (visual determination) was measured.

### Adhesion

The adhesion is determined using a standard Texture Analyzer (TA) and is tested by measuring the tensile strength of a sample (e.g. a plant-based chicken tender) without cooling (reference sample) and after cooling for about one hour (test sample). The process contains the cooling step was detailed in Example 13.

The analysis is performed by vertically withdrawing the reference sample and the test sample, from it's two sides for a distance of about 100 mm. The speed of the test is 10 mm/sec. The comparison between the test sample and the reference sample is performed by comparing of the Stress Strain curves obtained using a TA software.

### Example 1: Plant Based Chicken Style Cold Cut-Single Layer

The preparation of an exemplary plant-based chicken style cold cut is provided below.

### Materials and Methods

An emulsion composition was prepared including the components of Table 1A:

TABLE 1A
Plant based chicken style cold cut emulsion
composition (batch size 2900 g)

| | Amount per |
|---|---|
| Component | batch (g) |
| Water | 2400 |
| Maltodextrin | 28.3 |
| Hydroxypropylcellulose GF | 8.3 |
| Methylcellulose A4M | 47.5 |
| Hydroxypropyl | 3.3 |
| Methylcellulose K15M | |
| Sunflower Lecithin | 33.3 |
| Medium Chain | 80.8 |
| Triglyceride (MCT) | |
| Canola oil | 83.3 |
| Pea protein | 66.7 |
| Chickpea protein | 41.7 |
| Salt | 16.7 |
| Flavoring & Coloring | 43.0 |
| Citrus Fibers | 20.0 |
| Mannitol | 26.7 |
| Total | 2900 |

Specifically, water was added to a 4 L container and heated to about 70° C. Sunflower Lecithin, MCT and Canola oil were added to water and homogenized for about 10 minutes at about at 21.500 l/min. Pea Protein and chickpea Protein were added to emulsion and homogenized for about 10 minutes at 21.500 l/min. Salt, flavors, colors, and mannitol were added while homogenizing for 5 minutes. Maltodextrin, Methylcellulose, Hydroxypropyl Methylcellulose, Hydroxypropylcellulose and Citrus fibers were added, while homogenizing for 10 minutes.

The emulsion was transferred to a mixer and stirred at lowest speed for about 2 hours to cool down to ambient temperature and until a homogenous emulsion was obtained.

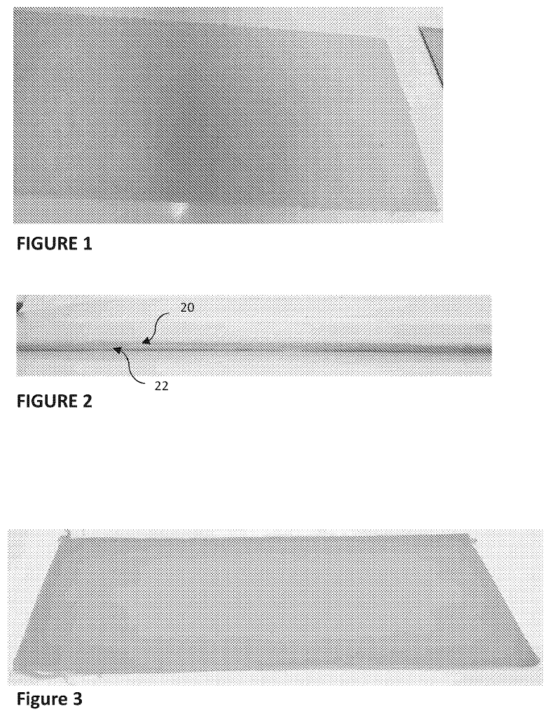

The emulsion was poured on a nonstick liner web, using a tabletop applicator with a 1000 μm gap. The emulsion was dried in an oven at 65° C. for about 40 minutes to obtain a chicken style cold cut film, an image of which is provided in FIG. 1

### Results

The viscosity of the emulsion is about 50,000 cP at 15° C. (spindle 4, 6 RPM).

The final dried product is a plant-based chicken style cold cut, thick, containing about 31% water and the composition of Table 1B:

TABLE 1B
Plant-Based Chicken Style Cold Cut - Final Composition

| | Amount |
|---|---|
| | per dry |
| Component | basis (%) |
| Water | 0 |
| Maltodextrin | 5.7 |
| Hydroxypropylcellulose GF | 1.7 |
| Methylcellulose A4M | 9.5 |
| Hydroxypropyl | 0.7 |
| Methylcellulose K15M | |
| Sunflower Lecithin | 6.7 |
| Medium Chain | 16.2 |
| Triglyceride (MCT) | |
| Canola oil | 16.7 |
| Pea protein | 13.3 |
| Chickpea protein | 8.3 |
| Salt | 3.3 |
| Flavoring & Coloring | 8.7 |
| Citrus Fibers | 4.0 |
| Mannitol | 5.3 |
| Total | 100 |

Organoleptic texture was similar to that of animal based cold cut with the ability to roll and band without immediate tearing similar to animal based cold cut.

Disintegration time was determined according to the procedure describe herein and was concluded about 12 minutes.

### Example 2: Plant Based Chicken Style Cold Cut-Two Layers

For the emulsion preparation of a two layered chicken style cold cut, the same procedure of Example 1 was performed.

The emulsion was poured on a nonstick liner web, using a tabletop applicator with a 1000 μm gap. The emulsion was dried in an oven at 65° C. for about 40 minutes to obtain a plant-based chicken style cold cut.

The first layer of the plant-based chicken style cold cut was then covered with the same emulsion using the tabletop applicator with 2000 μm gap. The two layers product was dried in an oven at 65° C. for about 35 minutes. The dry two-layer product was then peeled from the nonstick liner web and was placed with the opposite face on the nonstick liner web and inserted back in the oven at 65° C. for 10 min. An image of the two layered product is provided in FIG. 2.

### Results

The viscosity of the emulsion after cooling is about 50,000 cP at 15° C. (spindle 4, 6 RPM).

The 2-layered plant-based chicken style cold cut was 900 μm thick and contained the same composition/100 gr or per dry weight as the single layer in example No. 1.

Organoleptic texture was similar to that of animal based cold cut with the ability to roll and band without immediate tearing similar to animal based cold cut.

Disintegration time was determined according to the procedure describe herein and was concluded to be more than 30 minutes.

### Example 3: Plant Based Ham Style Cold Cut-Single Layer Rolled

An exemplary ham style cold cut was prepared using the same procedure of Example 1, with the emulsion components of Table 2A presented below.

TABLE 2A
Ham Style Cold Cut emulsion composition (batch size 880 g)

| | Amount per |
|---|---|
| Component | batch (g) |
| Water | 740.0 |
| Maltodextrin | 7.2 |
| Hydroxypropylcellulose GF | 3.3 |
| Methylcellulose A4M | 14.5 |
| Hydroxypropyl | 2.1 |
| Methylcellulose K15M | |
| Sunflower Lecithin | 11.7 |
| Medium Chain | 23.3 |
| Triglyceride (MCT) | |
| Canola oil | 25.3 |
| Pea protein | 14.0 |
| Soy protein | 14.0 |
| Salt | 2.6 |
| Flavoring & Coloring | 11.0 |
| Citrus Fibers | 4.7 |
| Mannitol | 6.4 |
| Total | 880 |

### Results

The viscosity of the emulsion after cooling is about 50,000 cP at 15° C. (spindle 4, 6 RPM).

The final dried product is a plant-based Ham style cold cut, 400 μm thick, containing about 30% water and the composition of Table 2B:

TABLE 2B
Plant-based Ham Style Cold Cut - Final Composition

| | Amount |
|---|---|
| | per dry |
| Component | basis (%) |
| Water | 0 |
| Maltodextrin | 5.2 |
| Hydroxypropylcellulose GF | 2.3 |
| Methylcellulose A4M | 10.3 |
| Hydroxypropyl | 1.5 |
| Methylcellulose K15M | |
| Sunflower Lecithin | 8.3 |
| Medium Chain | 16.7 |
| Triglyceride (MCT) | |
| Canola oil | 17.3 |
| Pea protein | 10.0 |
| Soy protein | 10.0 |
| Salt | 1.8 |
| Flavoring & Coloring | 7.8 |
| Citrus Fibers | 3.3 |
| Mannitol | 5.3 |
| Total | 100 |

FIG. 3 provides an image of a single layer of a ham style cold cut according to this non-limiting example.

Organoleptic texture was similar to that of animal based cold cut with the ability to roll and band the product without immediate tearing.

Disintegration time was determined according to the procedure describe herein and was resulted to about 12 minutes.

### Example 4: Plant Based Bacon Style Cold Cut with Two Distinct Colors-Single Layer Rolling

An exemplary preparation of a product containing two distinct colors was prepared by forming two types of emulsions which provided a bacon style cold cut. The composition of the emulsions is provided in Table 3A:

TABLE 3A
Emulsions' Composition for Bacon Style Cold Cut

| | Emulsion | Emulsion |
|---|---|---|
| Component | 1 (g) | 2 (g) |
| Water | 740 | 740 |
| Maltodextrin | 5.8 | 5.8 |
| Hydroxypropylcellulose GF | 4.2 | 4.2 |
| Methylcellulose A4M | 14.0 | 14.0 |
| Hydroxypropyl | 1.9 | 1.9 |
| Methylcellulose K15M | | |
| Sunflower Lecithin | 11.2 | 11.2 |
| Medium Chain | 23.3 | 23.3 |
| Triglyceride (MCT) | | |
| Canola oil | 25.7 | 25.7 |
| Pea protein | 14.0 | 14.0 |
| Chickpea protein | 14.0 | 14.0 |
| Salt | 3.3 | 3.3 |
| Flavoring & Coloring | 13.0 | 10.7 |
| Citrus Fibers | 5.1 | 5.1 |
| Mannitol | 4.4 | 6.8 |
| Total | 880 | 880 |

As noted above, the only difference between the two layers is in the flavoring and coloring and in the amount of mannitol.

Each emulsion was prepared according to the procedure provided in Example 1, the first emulsion was poured on a nonstick liner web with small gaps between each pure, using a tabletop applicator with a 1000μ gap, the second emulsion was poured in the gaps of the first emulsion.

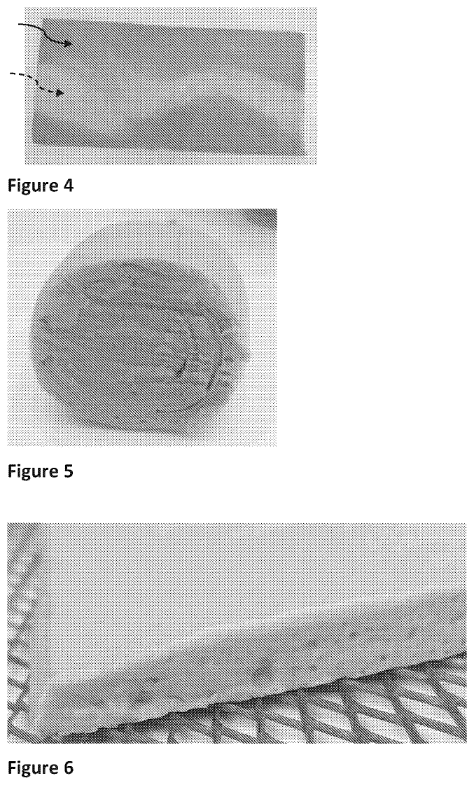

The emulsions were then dried in an oven at 65° C. for about 40 minutes and FIG. 4 provides an image of film, exhibiting the two distinct colors (marked by two distinct arrow types).

### Results

The final dried combined product is a plant-based Bacon style cold cut with two distinct colors, 400 μm thick, containing about 30% water and the composition of Table 3B:

TABLE 3B
Plant-Based Bacon Style Cold Cut Two Colors - Final Composition

| | Amount |
|---|---|
| | per dry |
| Component | basis (%) |
| Water | 0 |
| Maltodextrin | 4.2 |
| Hydroxypropylcellulose GF | 3.0 |
| Methylcellulose A4M | 10.0 |
| Hydroxypropyl | 1.3 |
| Methylcellulose K15M | |
| Sunflower Lecithin | 8.0 |
| Medium Chain | 16.7 |
| Triglyceride (MCT) | |
| Canola oil | 18.3 |
| Pea protein | 10.0 |
| Chickpea protein | 10.0 |
| Salt | 2.3 |
| Flavoring & Coloring | ~8.5 |
| Citrus Fibers | 3.7 |
| Mannitol | ~4 |
| Total | 100 |

Organoleptic texture was similar to that of animal based cold cut with the ability to roll and band the product without immediate tearing

Disintegration time was determined according to the procedure describe herein and was concluded to be about 12 min.

### Example 5: Plant Based Chicken Style Breast One Layer-Rolling

A chicken style breast was prepared according to the procedure of Example 1, using the emulsion composition of Table 4A, presented below.

TABLE 4A
Emulsion Composition for Chicken
Style Breast (batch size 2660 g)

| | Amount per |
|---|---|
| Component | batch (g) |
| Water | 2100 |
| Maltodextrin | 32.7 |
| Hydroxypropylcellulose GF | 6.5 |
| Methylcellulose A4M | 50.4 |
| Hydroxypropyl | 4.7 |
| Methylcellulose K15M | |
| Sunflower Lecithin | 38.3 |
| Coconut oil | 93.3 |
| Canola oil | 98.0 |
| Pea protein | 65.3 |
| Chickpea protein | 37.3 |
| Salt | 18.7 |
| Flavoring & Coloring | 57.0 |
| Citrus Fibers | 26.1 |
| Mannitol | 31.7 |
| Total | 2660 |

The emulsion was poured on a nonstick liner web, using tabletop applicator 1000 μm gap. The emulsion was dried in an oven at 65° C. for about 30 minutes.

After the drying the layer was taken out and was rolled on a non-stick food grade material to obtain a plant-based chicken breast, as shown in FIG. 5.

### Results

The viscosity of the emulsion after cooling is about 300,000 cP at 15° C. (spindle 4, 1.5 RPM).

The final dried product is a rolled one-layer plant-based chicken style breast, 4,500 μm thick, containing about 60% water and the composition of Table 4B:

TABLE 4B
Plant Based Chicken Style Breast - Final Composition

| | Amount |
|---|---|
| | per dry |
| Component | basis (%) |
| Water | 0 |
| Maltodextrin | 5.8 |
| Hydroxypropylcellulose GF | 1.2 |
| Methylcellulose A4M | 9.0 |
| Hydroxypropyl | 0.8 |
| Methylcellulose K15M | |
| Sunflower Lecithin | 6.8 |
| Coconut oil | 16.7 |
| Canola oil | 17.5 |
| Pea protein | 11.7 |
| Chickpea protein | 6.7 |
| Salt | 3.3 |
| Flavoring & Coloring | 10.2 |
| Citrus Fibers | 4.7 |
| Mannitol | 5.7 |
| Total | 100 |

Organoleptic texture was similar to that of animal based cold cut with the ability to roll and band the product without immediate tearing.

### Example 6: Plant Based Chicken Style Breast-Molding Layers

A plant-based chicken style breast, including several layers, was prepared, each layer was prepared from an emulsion based on the procedure of Example 1, and using the composition of Table 5A:

TABLE 5A
Emulsion composition for chicken style breast (batch size 2500 g)

| | Amount per |
|---|---|
| Component | batch (g) |
| Water | 2,000 |
| Maltodextrin | 20.8 |
| Methylcellulose A4M | 32.5 |
| Hydroxypropyl | 4.2 |
| Methylcellulose K15M | |
| Sunflower Lecithin | 27.5 |
| Canola oil | 116.7 |
| Pea protein | 58.3 |
| Chickpea protein | 100.0 |
| Salt | 8.3 |
| Flavoring & Coloring | 53.3 |
| Citrus Fibers | 36.7 |
| Mannitol | 41.7 |
| Total | 2500 |

The emulsion was then poured on a nonstick liner web, using stainless steel mold 1000 μm to form a layer. The emulsion was dried in an oven at 70° C. for about 10 minutes.

The layer was then taken out from the oven and another 1000 μm mold was placed on top of the previously created film while still within the mold. The addition amount of emulsion was poured into the mold and straightens out and went to the oven at 70° C. for about 10 minutes. This step was repeated about 8 times until an 8-layered product as images in FIG. 6 was formed.

The multi-layer product was put in the refrigerator at 4-8° C. for about one hour and thereafter. After cooling the product was inserted to the oven for another drying section of 30 min in 70° C.

### Results

The viscosity of the emulsion after cooling is about 300,000 cP at 15° C. (spindle 4, 1.5 RPM).

The final dried product is a molded 8 layers plant-based chicken style breast, 9,000 μm thick containing about 60% water and had the composition of Table 5B:

TABLE 5B
Plant Based Chicken Style Breast Stacking
Layers - Final Composition

| | Amount |
|---|---|
| | per dry |
| Component | basis (%) |
| Water | 0 |
| Maltodextrin | 4.2 |
| Methylcellulose A4M | 6.5 |
| Hydroxypropyl | 0.8 |
| Methylcellulose K15M | |
| Sunflower Lecithin | 5.5 |
| Canola oil | 23.3 |
| Pea protein | 11.7 |
| Chickpea protein | 20.0 |
| Salt | 1.7 |
| Flavoring & Coloring | 10.7 |
| Citrus Fibers | 7.3 |
| Mannitol | 8.3 |
| Total | 100 |

Organoleptic texture was similar to that of animal-based chicken breast with the ability to roll and band the product without immediate tearing

Disintegration time was determined according to the procedure describe herein and was concluded to be about 25 min.

### Example 7: Plant Based Breaded Chicken Breast Style (Schnitzel)—3 Times Stacking Layers

Breaded chicken breast style was prepared using an emulsion prepared with the composition of Table 6A, and the procedure of Example 1.

TABLE 6A
Emulsion Composition for Breaded Chicken
Breast Style (batch size 2,500 gr)

| | Amount per |
|---|---|
| Component | batch (g) |
| Water | 2000 |
| Maltodextrin | 20.8 |
| Methylcellulose GF | 32.5 |
| Hydroxypropyl | 4.2 |
| Methylcellulose K15M | |
| Sunflower Lecithin | 27.5 |
| Canola oil | 116.7 |
| Pea protein | 58.3 |
| Chickpea protein | 100.0 |
| Salt | 8.3 |
| Flavoring & Coloring | 53.3 |
| Citrus Fibers | 36.7 |
| Mannitol | 41.7 |
| Total | 2500 |

The emulsion was poured on a nonstick liner web, using stainless steel mold 1000 μm. The emulsion was dried in an oven at 70° C. for about 10 minutes.

The layer was taken out from the oven and another 1000 μm mold was placed on top of the mold. The emulsion was poured in the mold and straightens out and went to the oven at 70° C. for about 10 minutes. This step was repeated with 3 layers of mold, three times.

After receiving 3 stacks of 3 layers, the stacks were placed one on top of the other to obtain chicken breast like product.

The chicken breast style product was placed in a refrigerator at 4-8° C. for 1 hour, after one hour the chicken breast like was put in 70° C. for 30 min on stainless steel mesh.

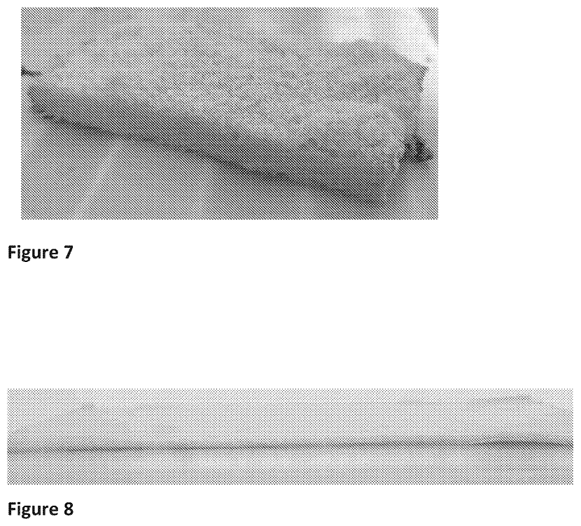

The chicken breast style product was covered with breadcrumbs from all sides and placed in a −18° C. freezer for about 12 hours, to obtain a breaded product for which an image is provided in FIG. 7. In this connection it is noted that the film forming polymers used in this example have higher solubility in low temperature, thus the cooling positively affects the stickiness of the film and improves the adhesion between the layers.

### Results

The viscosity of the emulsion after cooling is about 300,000 cP at 15° C. (spindle 4, 1.5 RPM).

The final dried product is a plant-based breaded chicken style breast, 9,000 μm thick, containing about 60% water and the composition of Table 6B:

TABLE 6B
Plant Based Breaded Chicken Style Breast - 3
Times Stacking Layers - Final Composition.

| | Amount |
|---|---|
| | per dry |
| Component | basis (%) |
| Water | 0 |
| Maltodextrin | 4.2 |
| Methylcellulose A4M | 6.5 |
| Hydroxypropyl | 0.8 |
| Methylcellulose K15M | |
| Sunflower Lecithin | 5.5 |
| Canola oil | 23.3 |
| Pea protein | 11.7 |
| Chickpea protein | 20.0 |
| Salt | 1.7 |
| Flavoring & Coloring | 10.7 |
| Citrus Fibers | 7.3 |
| Mannitol | 8.3 |
| Total | 100 |

Organoleptic texture was similar to that of animal-based chicken breast with the ability to roll and band the product without immediate tearing

Disintegration time was determined according to the procedure describe herein and was about 25 minutes.

### Example 8: Hybrid Hard Cheese with Whey Protein and Casein

Hybrid hard cheese containing non-animal recombinant milk proteins using an emulsion prepared with the composition of Table 7A, and the procedure of Example 1.

TABLE 7A
Emulsion composition for Hybrid Hard Cheese (batch size 818 g)

| | Amount per |
|---|---|
| Component | batch (g) |
| Water | 550 |
| Maltodextrin | 8.0 |
| Hydroxypropylcellulose GF | 8.0 |
| Methylcellulose A4M | 8.0 |
| Sunflower Lecithin | 24.0 |
| Coconut oil | 72.4 |
| Canola oil | 48.0 |
| Whey protein | 18.0 |
| Casein | 18.0 |
| Chickpea protein | 12.0 |
| Salt | 4.0 |
| Flavoring & Coloring | 1.6 |
| Calcium carbonate | 12.0 |
| Yeast extract | 14.0 |
| Mannitol | 20.0 |
| Total | 818.0 |

The emulsion was poured on a nonstick liner web, using a tabletop applicator with a 1000 μm gap. The emulsion was dried in an oven at 70° C. for about 30 minutes.

The layer was taken out from the oven and emulsion was poured on top of the layer using a tabletop applicator with a 2000 μm gap, the layers were dried in an oven at 70° C. for about 30 minutes.

The layers were taken out from the oven and emulsion was poured on top of the layers using tabletop applicator with 3000 μm gap. The emulsion was dried in an oven at 70° C. for about 30 minutes to obtain the hybrid hard cheese shown in FIG. 8.

### Results

The final dried product is a hybrid hard cheese, 2500 μm thick, containing about 60% water and the composition of Table 7B:

TABLE 7B
Hybrid Hard Cheese with Whey protein and Casein

| | Amount |
|---|---|
| | per dry |
| Component | basis (%) |
| Water | 0 |
| Maltodextrin | 3.0 |
| Hydroxypropylcellulose GF | 3.0 |
| Methylcellulose A4M | 3.0 |
| Sunflower Lecithin | 9.0 |
| Coconut oil | 27.0 |
| Canola oil | 17.9 |
| Whey protein | 6.7 |
| Casein | 6.7 |
| Chickpea protein | 4.5 |
| Salt | 1.5 |
| Flavoring & Coloring | 0.6 |
| Calcium carbonate | 4.5 |
| Yeast extract | 5.2 |
| Mannitol | 7.5 |
| Total | 100 |

Organoleptic texture was similar to that of animal based hard cheese with the ability to roll and band the product without immediate tearing

### Example 9: Hybrid Chicken Style Cold Cut with Chicken Muscle Cells

Hybrid Chicken Style Cold Cut containing non-animal cultured chicken muscle cells using an emulsion prepared with the composition of Table 8A, and the procedure of Example 1.

TABLE 8A
Emulsion composition for Chicken Style Cold Cut
with Chicken Muscle Cells (batch size 2900 g)

| Component | Amount per batch (g) |
|---|---|
| Water | 2400 |
| Maltodextrin | 26.7 |
| Hydroxypropylcellulose GF | 4.2 |
| Methylcellulose A4M | 38.3 |
| Hydroxypropyl Methylcellulose K15M | 5.0 |
| Sunflower Lecithin | 33.3 |
| Chicken muscle cell | 58.3 |
| Canola oil | 152.5 |
| Chickpea protein | 33.3 |
| Salt | 16.7 |
| Flavoring & Coloring | 57.5 |
| Citrus Fibers | 20.8 |
| Mannitol | 53.3 |
| Total | 2900 |

The emulsion was poured on a nonstick liner web, using a tabletop applicator with a 1000 μm gap. The emulsion was dried in an oven at 75° C. for about 20 minutes.

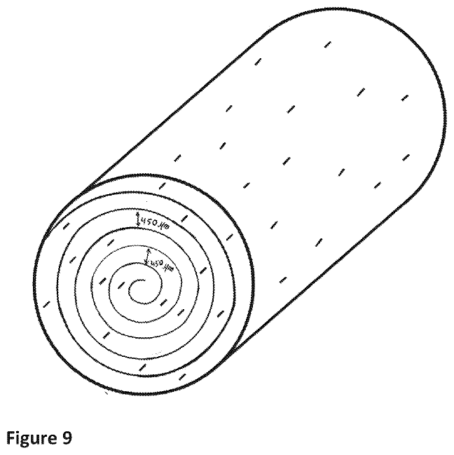

The layer was taken from the oven and was rolled on a non-stick material and placed in a refrigerator at 4-8° C. over night. FIG. 9 provides an illustration of a rolled hybrid product

### Results

The final dried product was a hybrid chicken style cold cut with chicken muscle cells, 4,500 μm thick, containing about 60% water and the composition of Table 8B:

TABLE 8B
Hybrid Chicken Style Cold Cut with Chicken
Muscle cells - Final Composition

| Component | Amount per dry basis (%) |
|---|---|
| Water | 0 |
| Maltodextrin | 5.3 |
| Hydroxypropylcellulose GF | 0.8 |
| Methylcellulose A4M | 7.7 |
| Hydroxypropyl Methylcellulose K15M | 1.0 |
| Sunflower Lecithin | 6.7 |
| Chicken muscle cell | 11.7 |
| Canola oil | 30.5 |
| Chickpea protein | 6.7 |
| Salt | 3.3 |
| Flavoring & Coloring | 11.5 |
| Citrus Fibers | 4.2 |
| Mannitol | 10.7 |
| Total | 100 |

Organoleptic texture was similar to that of animal based cold cut with the ability to roll and band the product without immediate tearing.

### Example 10: Hybrid Salmon Style Fish with Fish Adipocytes

Hybrid Salmon style fish containing non-animal cultured fish adipocytes emulsion prepared with the composition of Table 9A, and the procedure of Example 1.

TABLE 9A
Emulsion composition for Salmon Style Fish
with Fish Adipocytes (batch size 2900 g)

| Component | Amount per batch (g) |
|---|---|
| Water | 2400 |
| Maltodextrin | 26.7 |
| Hydroxypropylcellulose GF | 4.2 |
| Methylcellulose A4M | 38.3 |
| Hydroxypropyl Methylcellulose K15M | 5.0 |
| Sunflower Lecithin | 33.3 |
| Fish adipocytes | 58.3 |
| Canola oil | 152.5 |
| Chickpea protein | 33.3 |
| Salt | 16.7 |
| Flavoring & Coloring | 70.0 |
| Citrus Fibers | 8.3 |
| Mannitol | 53.3 |
| Total | 2900 |

The emulsion was poured on a nonstick liner web, using a tabletop applicator with a 1000 μm gap. The emulsion was dried in an oven at 65° C. for about 40 minutes.

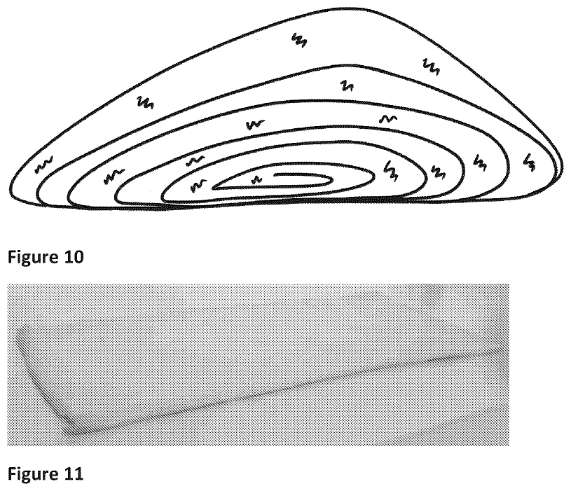

The layer was taken from the oven and was rolled on a non-stick material and placed in a refrigerator at 4-8° C. over night. FIG. 10 provides an illustration of a hybrid salmon product

### Results

The final dried product is a hybrid Salmon style fish with fish adipocytes, 40000 μm thick, containing about 32% water and the composition of Table 9B:

TABLE 9B
Hybrid Salmon Style Fish with Fish
Adipocytes - Final Composition

| Component | Amount per dry basis (%) |
|---|---|
| Water | 0 |
| Maltodextrin | 5.3 |
| Hydroxypropylcellulose GF | 0.8 |
| Methylcellulose A4M | 7.7 |
| Hydroxypropyl Methylcellulose K15M | 1.0 |
| Sunflower Lecithin | 6.7 |
| Fish adipocyte | 18.3 |
| Canola oil | 30.5 |
| Salt | 3.3 |
| Flavoring & Coloring | 8.7 |
| Citrus Fibers | 4.0 |
| Mannitol | 13.7 |
| Total | 100 |

Organoleptic texture was similar to that of Salmon with the ability to roll and band the product without immediate tearing

### Example 11: Plant Based Yellow Cheese

Plant based Yellow Cheese emulsion prepared with the composition of Table 10A, and the procedure of Example 1.

TABLE 10A
Emulsion composition for Plant Based
Yellow Cheese (batch size 688 g)

| Component | Amount per batch (g) |
|---|---|
| Water | 420 |
| Guar Gum | 32.0 |
| Xanthan Gum | 8.0 |
| Sunflower Lecithin | 28.0 |
| Coconut oil | 56.0 |
| Canola oil | 56.0 |
| Chickpea protein | 48.0 |
| Pea protein | 16.0 |
| Salt | 4.8 |
| Flavoring & Coloring | 3.2 |
| Calcium carbonate | 4.8 |
| Yeast extract | 3.2 |
| Mannitol | 8.0 |
| Total | 688.0 |

The emulsion was poured on a nonstick liner web, using a tabletop applicator with a m1000 μm gap. The emulsion was dried in an oven at 70° C. for about 25 minutes.

The layer was taken out from the oven and emulsion was poured on top of the layer using a tabletop applicator with a 2000 μm gap, the layers were dried in an oven at 70° C. for about 25 minutes.

The layers were taken out from the oven and emulsion was poured on top of the layers using tabletop applicator with 3000 μm gap. The emulsion was dried in an oven at 70° C. for about 25 minutes and a plant based hard cheese slice (sheet-like) was obtained, as shown in the image of FIG. 11.

The plant base hard cheese was stored in a refrigerator at 4-8° C. over night.

### Results

The final product is a plant-based yellow cheese, 1200 μm thick, containing about 40% water and the composition of Table 10B:

TABLE 10B
Plant Based Yellow Cheese - Final Composition

| Component | Amount per dry basis (%) |
|---|---|
| Water | 0 |
| Guar Gum | 11.9 |
| Xanthan Gum | 3.0 |
| Sunflower Lecithin | 10.4 |
| Coconut oil | 20.9 |
| Canola oil | 20.9 |
| Chickpea protein | 17.9 |
| Pea protein | 6.0 |
| Salt | 1.8 |
| Flavoring & Coloring | 1.2 |
| Calcium carbonate | 1.8 |
| Yeast extract | 1.2 |
| Mannitol | 3.0 |
| Total | 100 |

Organoleptic texture was similar to that of animal based yellow cheese with the ability to roll and band the product without immediate tearing

### Example 12: Plant Base Hard Cheese (Feta Style)

Plant based hard cheese emulsion prepared with the composition of Table 11A, and the procedure of Example 1.

TABLE 11A
Emulsion composition for Plant Based Hard
Cheese Feta Style (batch size 688 g)

| Component | Amount per batch (g) |
|---|---|
| Water | 420 |
| Starch | 31.6 |
| Carboxymethyl cellulose - Sodium Salt | 8.0 |
| Sunflower Lecithin | 20.0 |
| Coconut oil | 44.0 |
| Canola oil | 44.0 |
| Chickpea protein | 48.0 |
| Pea protein | 16.0 |
| Salt | 4.0 |
| Flavoring & Coloring | 4.4 |
| Calcium carbonate | 8.8 |
| Yeast extract | 8.0 |
| Mannitol | 30.8 |
| Total | 688.0 |

The emulsion was poured on a nonstick liner web, using a stainless-steel mold 1000 μm. The emulsion was dried in an oven at 70° C. for about 20 minutes.

The layer was taken out from the oven and emulsion was poured on top of the layer using a stainless-steel mold 1000 μm, the layers were dried in an oven at 70° C. for about 20 minutes.

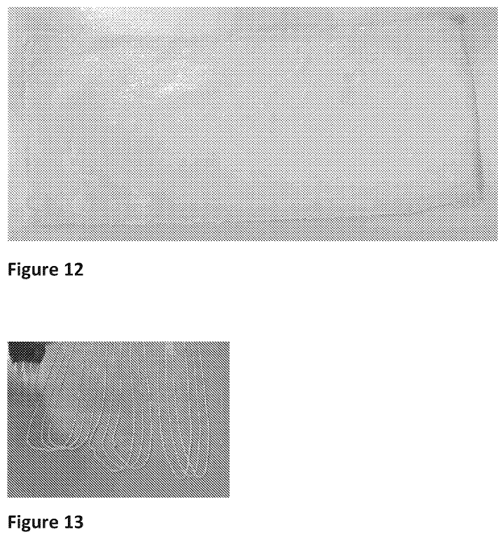

The layers were taken out from the oven and emulsion was poured on top of the layers using stainless steel mold 1000 μm. The emulsion was dried in an oven at 70° C. for about 20 minutes. Eventually, a Feta like cheese was obtained, a picture of which is provided in FIG. 12.

The plant base hard cheese was stored in a refrigerator at 4-8° C. over night

### Results

The final product is a plant-based hard cheese, 2500 μm thick, containing about 40% water and the composition of Table 11B:

TABLE 11B
Plant Base Hard Cheese - Final Composition

| Component | Amount per dry basis (%) |
|---|---|
| Water | 0 |
| Starch | 11.9 |
| Carboxymethyl cellulose - Sodium Salt | 3.0 |
| Sunflower Lecithin | 7.5 |
| Coconut oil | 16.4 |
| Canola oil | 16.4 |
| Chickpea protein | 17.9 |
| Pea protein | 6.0 |
| Salt | 1.5 |
| Flavoring & Coloring | 1.6 |
| Calcium carbonate | 3.3 |
| Yeast extract | 3.0 |
| Mannitol | 11.5 |
| Total | 100 |

Organoleptic texture was similar to that of animal based hard cheese with the ability to roll and band the product without immediate tearing.

### Example 13: Plant Based Chicken Style Breast Having Fibrillar/Thread Structure

An emulsion composition was prepared including the components of Table 4A (Example 5 above):

Emulsions from this composition was prepared as described in Example 1 above.

The emulsions were pressed through a set of nozzles to form elongated threads.

Each nozzle had a diameter of between about 1 mm and about 3 mm. The resulting elongated threads having a diameter of between about 1 mm and about 3 mm were disposed on a non-stick liner web as shown in FIG. 13 with a distance of about 1 cm between each elongated thread.

The elongated threads were dried in an oven at 70° C. for about 5 minutes.

After the drying, the threads were bundled and arranged manually or by using a mold such that all the threads were aligned one to the other.

The resulting bundled product was cooled (4° C.) for about 1 hr to cause adhesion between the threads. Subsequently, the bundled product was further dried in the oven (70° C.) for about 30 min to obtain a chicken breast analogue product.

The moisture content was measured as described above and it was found to be about 45-55%.

### Results

The viscosity of the emulsion after cooling is about 300,000 cP at 15° C. (spindle 4, 1.5 RPM).

The thickness/diameter of the threads after drying as measured by a caliper was between about 0.3 mm and about 1 mm.

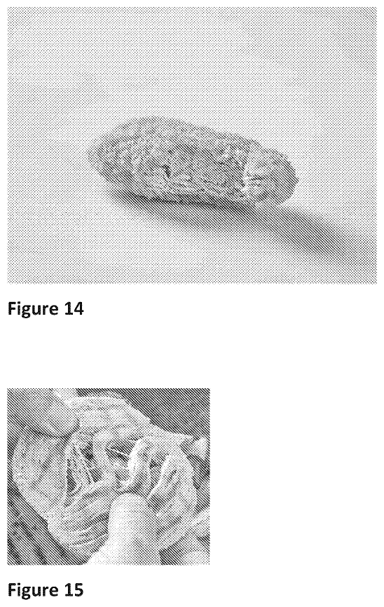

The resulting chicken breast analogue product had the characteristics both and taste, texture and appearance of chicken breast. FIG. 14 provides an image of the resulting chicken breast analogue product as a form of a breaded tender, showing fibril structure and FIG. 15 provides an image of the resulting chicken breast analogue product. Both products are characterized by having a “chicken” like fibrial structure.

The composition of chicken breast analogue product is provided in Table 12:

TABLE 12
Plant Based Chicken Breast Analogue Product

| Component | Amount per dry basis (%) |
|---|---|
| Water | 0 |
| Maltodextrin | 5.8 |
| Hydroxypropylcellulose GF | 1.2 |
| Methylcellulose A4M | 9.0 |
| Hydroxypropyl Methylcellulose K15M | 0.8 |
| Sunflower Lecithin | 6.8 |
| Coconut oil | 16.7 |
| Canola oil | 17.5 |
| Pea protein | 11.7 |
| Chickpea protein | 6.7 |
| Salt | 3.3 |
| Flavoring & Coloring | 10.2 |
| Citrus Fibers | 4.7 |
| Mannitol | 5.7 |
| Total | 100 |

The plant-based chicken breast analogue product is examined by a texture analyzer as described above.

### Example 14: Plant Based Fibrillar Structure Chicken Style Breast

The homogenous emulsion is obtained as described in Example 13.

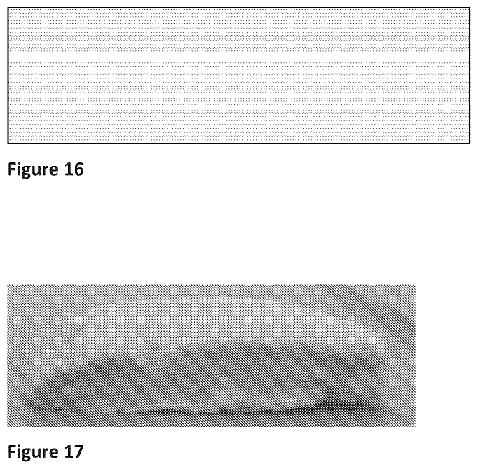

The emulsion is poured on a nonstick liner web into a stainless-steel mold of 1000 μm high with gaps as shown in FIG. 16, of about 1 mm to form elongated strips.

The elongated strip is dried in an oven at 70° C. for about 5 minutes.

After the drying, the strips are treated as described in Example 13.

### Example 15: Plant Based Chicken Style Breast (Non Working Example)

TABLE 13A
Emulsion composition for Plant Based Chicken
Style Breast (batch size 2500 g)

| Component | Amount per batch (g) |
|---|---|
| Water | 2000 |
| Maltodextrin | 20.8 |
| Methylcellulose A4M | 32.5 |
| Hydroxypropyl Methylcellulose K15M | 4.2 |
| Sunflower Lecithin | 27.5 |
| Canola oil | 116.7 |
| Pea protein | 58.3 |
| Chickpea protein | 100.0 |
| Salt | 8.3 |
| Flavoring & Coloring | 53.3 |
| Citrus Fibers | 36.7 |
| Mannitol | 41.7 |
| Total | 2500 |

The emulsion was poured on a nonstick liner web, using stainless steel mold of 8000 μm. The emulsion was dried in an oven at 70° C. for about 50 minutes.

The chicken breast like product was placed in a refrigerator at 4-8° C. for 1 hour, after one hour the chicken breast like was put in 70° C. for 15 min on stainless steel mesh.

### Results

The final product is a plant-based chicken style breast, 7000 μm thick, containing about 70% water, an image of which is provided in FIG. 17, and the composition thereof is provided in Table 13B:

TABLE 13B
Plant based chicken style breast - Final Composition.

| Component | Amount per dry basis (%) |
|---|---|
| Water | 0 |
| Maltodextrin | 4.2 |
| Methylcellulose A4M | 6.5 |
| Hydroxypropyl Methylcellulose K15M | 0.8 |
| Sunflower Lecithin | 5.5 |
| Canola oil | 3.3 |
| Pea protein | 11.7 |
| Chickpea protein | 20.0 |
| Salt | 1.7 |
| Flavoring & Coloring | 10.7 |
| Citrus Fibers | 7.3 |
| Mannitol | 28.3 |
| Total | 100 |

The chicken style breast was too wet due to the drying in single thick layer of 8000 μm as also evident from FIG. 17 and a continuous film was not formed.

It is noted that the disintegration time was about 8 minutes.

### Example 16: Non-Working (Reference #3) Plant-Based Chicken Style Breast

Plant based Chicken Style Breast prepared with the composition of Table 13A and the procedure of Example 1.

TABLE 14A
Emulsion Composition for Plant Based
Chicken Style Breast (1700 g)

| Component | Amount per batch (g) |
|---|---|
| Water | 1200 |
| Maltodextrin | 75.0 |
| Hydroxypropylcellulose GF | 0 |
| Methylcellulose A4M | 5.8 |
| Hydroxypropyl Methylcellulose K15M | 0 |
| Sunflower Lecithin | 27.5 |
| Coconut oil | 0 |
| Canola oil | 116.7 |
| Pea protein | 58.3 |
| Chickpea protein | 91.7 |
| Salt | 8.3 |
| Flavoring & Coloring | 46.6 |
| Citrus Fibers | 36.7 |
| Mannitol | 33.3 |
| Total | 1700 |

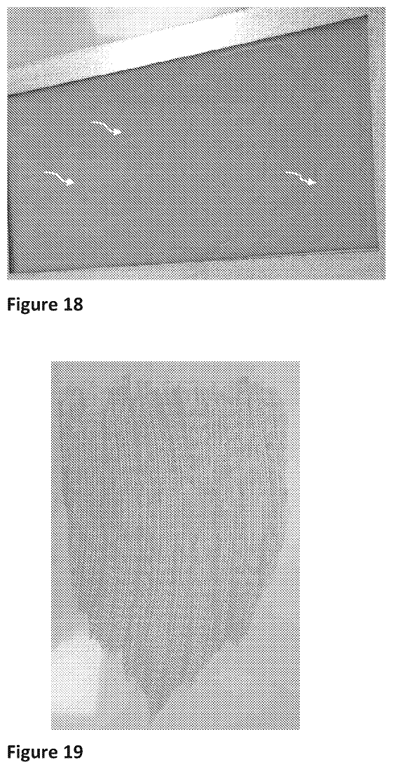

The emulsion was poured on a nonstick liner web, using tabletop applicator 1000 μm gap. The emulsion was dried in an oven at 65° C. for about 30 minutes. FIG. 18 provides an image of the resulting product, showing the lack of continuity/lack of intact film due to the low amount (below 2%) of the viscosity increasing hydrocolloid forming polymers. The low amount of these polymers also resulted in a sandy mouth feel. The water and the composition of Table 14B:

TABLE 14B
Plant Based Chicken Style Breast - Final Composition

| Component | Amount per dry basis (%) |
|---|---|
| Water | 0 |
| Maltodextrin | 15.0 |
| Hydroxypropylcellulose GF | 0 |
| Methylcellulose A4M | 1.2 |
| Hydroxypropyl Methylcellulose K15M | 0 |
| Sunflower Lecithin | 5.5 |
| Coconut oil | 0 |
| Canola oil | 23.3 |
| Pea protein | 11.7 |
| Chickpea protein | 18.3 |
| Salt | 1.7 |
| Flavoring & Coloring | 9.3 |
| Citrus Fibers | 7.3 |
| Mannitol | 6.7 |
| Total | 100 |

The chicken style breast was too wet, cracked and not continuous due to the lack of viscosity increasing hydrocolloid forming polymers. The lack of these important polymers was also evident from the short disintegration time of about 1 minute.

### Example 17: Plant Based Salmon Fillet Having Fibrillar/Thread Structure

A Salmon fillet was prepared according to the procedure of Example 1, using the emulsion composition of Table 15A, presented below.

TABLE 15A
Emulsion Composition for Salmon fillet (batch size 2660 g)

| Component | Amount per batch (g) |
|---|---|
| Water | 2100 |
| Methylcellulose A4M | 28.0 |
| Hydroxypropyl Methylcellulose K15M | 4.7 |
| Sunflower Lecithin | 9.3 |
| Canola oil | 130.7 |
| Soy protein TVP (Textured Vegetable Protein) | 322 |
| Salt | 20.5 |
| Flavoring & Coloring | 3.7 |
| Citrus Fibers | 41.1 |
| Total | 2660 |

The emulsion was poured on a nonstick liner web, using tabletop applicator 1 mm gap that defines the height of the threads, this layer was converted to a thin threads using a dedicated comb as shown in FIG. 19. The comb has gaps of 1 mm between the teeth that defines the wet width of the threads. The distance between the comb teeth is 1 mm that defines the distance between the wet threads. The threads were dried in an oven at 70° C. for about 30-120 seconds.

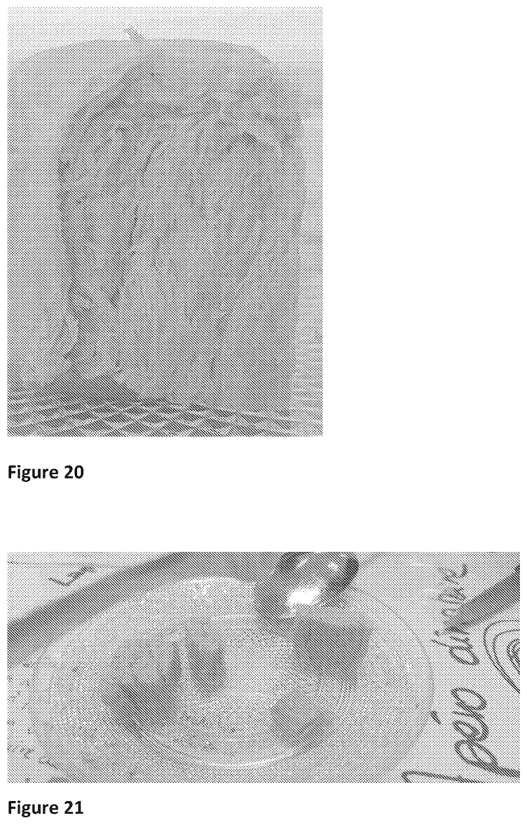

The resulting elongated threads having a diameter of between about 0.1 mm and about 0.6 mm as shown in FIG. 20.

After the drying, the threads were bundled and arranged manually or by using a mold such that all the threads were aligned one to the other.

The resulting bundled product was cooled (4° C.) for about 1 hr to cause adhesion between the threads. Subsequently, the bundled product was cut to a slices of 2 cm length, 2 cm width and 1 cm high and further fried in the pan using about 200° C. for about 1 min on each side to obtain a Salmon fillet analogue product. The threads are arranged in a vertical orientation as shown in FIG. 21 to mimic the muscle fibers of Salmon fish.

The moisture content was measured as described above and it was found to be about 35-55%.

### Results

The viscosity of the emulsion after cooling is about 300,000 cP at 15° C. (spindle 4, 1.5 RPM).

The thickness/diameter of the threads after drying as measured by a caliper was between about 0.1 mm and about 0.6 mm.

The resulting Salmon fillet analogue product had the characteristics both and taste, texture and appearance of Salmon fillet. FIG. 21 provides an image of the resulting Salmon fillet analogue product, showing fibril structure.

The composition of Salmon fillet analogue product is provided in Table 15B:

TABLE 15B
Plant Based Salmon fillet - Final Composition

| Component | Amount per dry basis (%) |
|---|---|
| Water | 0 |
| Methylcellulose A4M | 5.0 |
| Hydroxypropyl Methylcellulose K15M | 0.8 |
| Sunflower Lecithin | 1.7 |
| Canola oil | 23.3 |
| Soy protein TVP | 57.5 |
| Salt | 3.7 |
| Flavoring & Coloring | 0.7 |
| Citrus Fibers | 7.3 |
| Total | 100 |

Organoleptic texture was similar to that of animal based Salmon fillet with the ability to roll and band the product without immediate tearing.

1-81. (canceled)

82. A plant-based edible hydrogel film comprising a homogenous blend of at least one hydrocolloid forming polymer, a protein, a lipid and water; wherein
said at least one hydrocolloid forming polymer comprises one or more viscosity increasing polymers, each viscosity increasing polymers having a viscosity of at least 1,000 cP at 25° C., when dissolved in water, at a concentration of about 2% (w/v); and
said one or more viscosity increasing polymers being in a total amount of between 2 wt % and 20 wt % out of the total dry weight of the hydrogel film.

83. The plant-based edible hydrogel film of claim 82, wherein said hydrocolloid forming polymer and/or the viscosity increasing polymer comprises a polysaccharide, optionally wherein said polysaccharide is selected from the group consisting of methyl cellulose, hydroxypropylmethylcellulose, xanthan gum, guar gum, carboxymethylcellulose and any combination of same optionally wherein the polysaccharide comprises cellulose.

84. The plant-based edible hydrogel film of claim 83, wherein the cellulose comprises (i) methylcellulose (MC), optionally wherein the MC has a viscosity of at least about 4,000 cP at 25° C., when dissolved in water at a concentration of about 2 wt %; (ii) a hydroxypropylmethylcellulose (HPMC) having a viscosity at 25° C., of at least about 10,000 cP, or about 15,000 cP, or between about 10,000 cP and about 15,000 cP, when dissolved in water at a concentration of 2 wt % and/or (iii) a carboxymethylcellulose (CMC) having a viscosity at 25° C., of at least about 1,500 cP, or between about 1,500 cP and about 3,000 cP, when dissolved in water at a concentration of 1 wt %.

85. The plant-based edible hydrogel film of claim 82, wherein the viscosity increasing polymer comprises a nature-derived polysaccharide, optionally (i) wherein said nature-derived polysaccharide is xanthan gum having a viscosity at 25° C., of between 1,000 cP and about 2,000 cP, when dissolved in water at a concentration of 1 wt % and/or (ii) wherein said nature-derived polysaccharide is guar gum having a viscosity at 25° C., of at least about 3,000 cP or between about 3,000 cP and about 5,000 cP, when dissolved in water at a concentration of 1 wt %.

86. The plant-based edible hydrogel film of claim 82, comprising at least one hydrocolloid forming polymer other than the viscosity increasing polymer, optionally wherein the at least one other hydrocolloid forming polymer is a polysaccharide having a viscosity of less than 1,000 cP at 25° C., when dissolved in water, at a concentration of about 2% (w/v), optionally wherein the at least one other hydrocolloid forming polymer is selected from the group consisting of maltodextrin, hydroxypropylcellulose (HPC).

87. The plant-based edible hydrogel film of claim 82, comprising a combination of two viscosity increasing polymers, optionally comprising a combination of MC and HPMC, optionally comprising MC in an amount of at least 0.1 wt % optionally, comprising HPMC in an amount of at least 0.1 wt %.

88. The plant-based edible hydrogel film of claim 82, comprising (i) maltodextrin, optionally in an amount of at least 0.1 wt % (ii) a combination of maltodextrin, MC and HPMC and optionally HPC, and/or (iii) a combination of xanthan gum and guar gum.

89. The plant-based edible hydrogel film of claim 82, comprising at least one plant-based protein, optionally wherein said legume protein or bean proteins is selected from the group consisting of soy protein, pea protein, chickpea protein, lupine protein, mung-bean protein, kidney bean protein, black bean protein, alfalfa protein and any combination of same optionally, wherein said plant-based protein comprises at least chickpea protein optionally wherein said plant-based protein comprises a combination of at least pea protein and chickpea protein.

90. The plant-based edible hydrogel film of claim 82, comprising an animal cell or animal cell component, optionally wherein said animal cell or animal cell component is selected from adipocytes, muscle cell, bone cell, connective cells, epithelial cells, fibroblast, stem cells and any combination of same.

91. The plant-based edible hydrogel film claim 82, comprising one or more of (i) an emulsifier, optionally wherein said emulsifier comprises lecithin optionally said lecithin is selected from the group consisting of sunflower lecithin and soy lecithin, (ii) a filler, optionally said filler is selected from the group consisting of starch, mannitol, hydrogenated starch hydrolysates, sorbitol, sucrose, maltitol, isomalt, lactitol, maltitol, sorbitol, xylitol, erythritol, calcium carbonate and any combination thereof, and/or (iii) fibers.

92. The plant-based edible hydrogel film of claim 82, wherein said lipid comprises plant derived oil, optionally wherein said plant derived oil is selected from the group consisting of canola oil, coconut oil, and any combination of same optionally wherein said lipid comprises short triglycerides.

93. The plant-based edible hydrogel film of claim 82, having a water content of between 20% v/v and 90% v/v.

94. The plant-based edible hydrogel film of claim 82, wherein said film (i) has a thickness of between 50 μm and 3,000 μm and/or (ii) being in a form of a sheet or strip and/or (iii) being in a form of a thread.

95. A plant-based food product comprising at least one plant-based edible hydrogel film, said plant-based edible hydrogel film is defined in claim 82, optionally (i) at least one plant-based edible hydrogel film being in a folded or rolled configuration, optionally comprising spirally wound plant-based edible hydrogel film, and/or at least one plant-based edible hydrogel film folded in a zig-zag arrangement, (ii) two or more hydrogel films being essentially stacked one on top of another, optionally wherein at least a portion of each edible hydrogel film is adhered to its neighboring film, optionally comprising a plurality of the same or different plant based edible hydrogel films.

96. The plant-based food product of claim 95, being a plant-based meat analogue or a plant based dairy analogue being one or more of:
I. a plant-based chicken meat analogue product comprising at least two plant-based edible hydrogel films, each film, which can be the same or different, comprise a homogenous blend of hydrocolloid forming polymers, a protein, a lipid and water; wherein
(a) said hydrocolloid forming polymers are in an amount of between about 11.8 wt % and about 12.1 wt % out of the total dry weight of the meat analogue,
(b) said hydrocolloid forming polymers comprise at least two viscosity increasing polymers, each viscosity increasing polymers having a viscosity of at least 4,000 cP at 25° C., when dissolved in water, at a concentration of about 2% (w/v);
(c) said at least two viscosity increasing polymers are in a total amount of between about 10 wt % and about 10.5 wt % out of the total dry weight of the meat analogue; and
(d) said at least two viscosity increasing polymers comprise HPMC and MC, optionally wherein the two viscosity-increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v), optionally comprising maltodextrin in an amount of about 5.7 wt %, sunflower lecithin in an amount of about 6.7 wt %, medium chain triglyceride (MCT) in an amount of about 16.2 wt %, canola oil in an amount of about 16.7 wt %, pea protein in an amount of about 13.3 wt %, chickpea protein in an amount of about 8.3 wt %, salt in an amount of about 3.3 wt %, citrus fibers in an amount of about 4 wt %, mannitol in an amount of about 5.3 wt % and flavoring and colorants, each amount being out of the total dry weight of the food product;
II. a plant-based chicken meat analogue product comprising at least two hydrogel films, each film, which can be the same or different, comprise a homogenous blend of a hydrocolloid forming polymer, a protein, a lipid and water; wherein
(a) said hydrocolloid forming polymer comprises at least two viscosity increasing polymers, each viscosity increasing polymers having a viscosity of at least 4,000 cP at 25° C., when dissolved in water, at a concentration of about 2% (w/v)
(b) said two viscosity increasing polymers being in a total amount of between about 7.1 wt % and about 7.3 wt % out of the total dry weight of the food product; and
(c) said viscosity increasing polymers comprise HPMC and MC, optionally
wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v), optionally comprising maltodextrin in an amount of about 4.2 wt %, sunflower lecithin in an amount of about 5.5 wt %, canola oil in an amount of about 23.3 wt %, pea protein in an amount of about 11.7 wt %, chickpea protein in an amount of about 20.0 wt %, salt in an amount of about 1.7 wt %, citrus fibers in an amount of about 7.3 wt %, mannitol in an amount of about 8.3 wt % and flavoring and colorants, each amount being out of the total dry weight of the food product;
III. a plant-based chicken meat analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymers having a viscosity of at least 4,000 cP at 25° C., when dissolved in water, at a concentration of about 2% (w/v);
(b) said at least two viscosity increasing polymers comprise HPMC and MC, being in a total amount of between about 8.6 wt % and about 8.8 wt % out of the total dry weight of the chicken meat analogue product, optionally wherein said two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v), optionally comprising (i) maltodextrin in an amount of about 5.3 wt %, sunflower lecithin in an amount of about 6.7 wt %, canola oil in an amount of about 30.5 wt %, chicken muscle cell in an amount of about 11.5 wt %, salt in an amount of about 3.3 wt %, citrus fibers in an amount of about 4.2 wt %, mannitol in an amount of about 10.7 wt % and flavoring and colorants, each amount being out of the total dry weight of the chicken analogue; (ii) maltodextrin in an amount of about 5.3 wt %, sunflower lecithin in an amount of about 6.7 wt %, canola oil in an amount of about 30.5 wt %, fish adipocyte cells in an amount of about 18.3 wt %, salt in an amount of about 3.3 wt %, citrus fibers in an amount of about 4.0 wt %, mannitol in an amount of about 13.7 wt % and flavoring and colorants, each amount being out of the total dry weight of the chicken analogue;
IV. a plant-based ham analogue product comprising at least two plant-based hydrogel films, each film, which can be the same or different, comprise a homogenous blend of hydrocolloid forming polymers, a protein, a lipid and water; wherein
(a) said hydrocolloid forming polymer comprises at least two viscosity increasing polymers, each viscosity increasing polymers having a viscosity of at least 4,000 cP at 25° C., when dissolved in water, at a concentration of about 2% (w/v);
(b) said at least two viscosity increasing polymers comprising MC and HPMC in a total amount of between about 11.6 wt % and about 12.0 wt % out of the total dry weight of the ham analogue product, optionally wherein said two viscosity increasing polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v), optionally comprising maltodextrin in an amount of about 5.2 wt %, sunflower lecithin in an amount of about 8.3 wt %, medium chain triglyceride (MCT) in an amount of about 16.7 wt %, canola oil in an amount of about 17.3 wt %, pea protein in an amount of about 10.0 wt %, chickpea protein in an amount of about 10.0 wt %, salt in an amount of about 1.8 wt %, citrus fibers in an amount of about 3.3 wt %, mannitol in an amount of about 5.3 wt % and flavoring and colorants, each amount being out of the total dry weight of the plant based ham analogue;
V. a plant-based bacon analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymers having a viscosity of at least 4,000 cP at 25° C., when dissolved in water, at a concentration of about 2% (w/v);
(b) said at least two viscosity increasing polymers being in a total amount of between about 11.2 wt % and about 11.6 wt % out of the total dry weight of the bacon analogue product; and
(c) said at least two viscosity increasing polymers comprise HPMC and MC, optionally wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v), optionally comprising maltodextrin in an amount of about 4.2 wt %, sunflower lecithin in an amount of about 8.0 wt %, medium chain triglyceride (MCT) in an amount of about 16.7 wt %, canola oil in an amount of about 16.7 wt %, pea protein in an amount of about 10.0 wt %, chickpea protein in an amount of about 10.0 wt %, salt in an amount of about 2.3 wt %, citrus fibers in an amount of about 3.7 wt %, mannitol in an amount of between about 3.2 wt % and about 4.8 wt % and flavoring and colorants, each amount being out of the total dry weight of the bacon analogue product;
VI. a plant-based cheese analogue product comprising at least two plant-based edible hydrogel films, each edible hydrogel film, which can be the same or different, comprise a homogenous blend of hydrocolloid forming polymers, a protein, a lipid and water; wherein
(a) said hydrocolloid forming polymers are in a total amount of about 6 wt % out of the total dry weight of the cheese product;
(b) said hydrocolloid forming polymers comprise at least one viscosity increasing polymer having a viscosity of at least 4,000 cP at 25° C., when dissolved in water, at a concentration of about 2% (w/v)
(c) said at least one viscosity increasing polymer being in a total amount of about 3.0 wt % out of the total dry weight of the cheese analogue product; and
(d) said at least one viscosity increasing polymer comprise MC, optionally wherein said at least one viscosity increasing polymer comprise or consist essentially of MC having a viscosity of about 4,000 cP at 25° C., when dissolved in water, at a concentration of about 2% (w/v), optionally comprising maltodextrin in an amount of about 3.0 wt %, sunflower lecithin in an amount of about 9.0 wt %, medium chain triglyceride (MCT) in an amount of about 16.7 wt %, canola oil in an amount of about 17.9 wt %, coconut oil in an amount of about 27 wt %, chickpea protein in an amount of about 4.5 wt %, whey protein in an amount of about 6.7 wt %, casein protein in an amount of about 6.7 wt %, salt in an amount of about 1.5 wt %, mannitol in an amount of about 7.5 wt %, calcium carbonate in an amount of about 4.5 wt %, yeast extract in an amount of about 5.2 wt % and flavoring and colorants, each amount being out of the total dry weight of the cheese analogue product;
VII. a plant-based salmon meat analogue product comprising at least two hydrogel films, each film, which can be the same or different, comprise a homogenous blend of hydrocolloid forming polymers, a protein, a lipid and water; wherein
(a) said hydrocolloid forming polymers comprise at least two viscosity increasing polymers, each viscosity increasing polymer having a viscosity of at least 4,000 cP at 25° C., when dissolved in water, at a concentration of about 2% (w/v);
(b) said at least two viscosity increasing polymers comprise HPMC and MC, being in a total amount of about 8.7 wt % out of the total dry weight of the salmon meat analogue product, optionally wherein said two viscosity increasing hydrocolloid forming polymers comprise or consist essentially of (i) MC having a viscosity of about 4,000 cP at 25° C., when dissolved in water, at a concentration of about 2% (w/v) and (ii) HPMC having a viscosity of about 15,000 cP at 25° C., when dissolved in water, at a concentration of about 2% (w/v);
VIII. a plant-based yellow cheese analogue product comprising at least two plant-based edible hydrogel films, each film, which can be the same or different, comprise a homogenous blend of hydrocolloid forming polymers, a protein, a lipid and water; wherein
(a) said hydrocolloid forming polymers comprise at least two viscosity increasing hydrocolloid forming polymers, each viscosity increasing hydrocolloid forming polymers having a viscosity of at least 1,000 cP at 25° C., when dissolved in water, at a concentration of about 2% (w/v);
(b) said two viscosity increasing hydrocolloid forming polymers comprises xanthan gum and guar gum in a total amount of about 12.2 wt % out of the total dry weight of the yellow cheese analogue product, optionally comprising sunflower lecithin in an amount of about 10.4 wt %, canola oil in an amount of about 20.9 wt %, coconut oil in an amount of about 20.9, pea protein in an amount of about 6 wt %, chickpea protein in an amount of about 17.9 wt %, salt in an amount of about 1.8 wt %, mannitol in an amount of about 3.0 wt %, yeast extract in an amount of about 1.2 wt % and flavoring and colorants, each amount being out of the total dry weight of the yellow cheese analogue; or
IX. a plant-based hard cheese analogue product comprising at least two plant-based edible hydrogel films, each film, which can be the same or different, comprise a homogenous blend of at least one hydrocolloid forming polymer, a protein, a lipid and water; wherein
(a) said at least one hydrocolloid forming polymer comprise at least one viscosity increasing polymer having a viscosity of at least 1,500 cP at 25° C., when dissolved in water, at a concentration of about 2% (w/v);
(b) said at least one viscosity increasing polymer comprises CMC in an amount of about 3.0 wt % out of the total dry weight of the hard cheese analogue product; and
(c) said homogenous blend comprises starch in an amount of about 11.9 wt %, optionally comprising sunflower lecithin in an amount of about 7.5 wt %, canola oil in an amount of about 16.4 wt %, coconut oil in an amount of about 16.4, pea protein in an amount of about 6.0 wt %, chickpea protein in an amount of about 17.9 wt %, salt in an amount of about 1.5 wt %, mannitol in an amount of about 11.5 wt %, yeast extract in an amount of about 3.0 wt % and flavoring and colorants, each amount being out of the total dry weight of the food product.

97. A method of forming a plant-based edible hydrogel film, comprising
(c) providing an emulsion composition comprising a homogenous blend of at least one hydrocolloid forming polymer, a protein, a lipid and water, wherein
(d) said hydrocolloid forming polymer comprises one or more viscosity increasing polymers, each viscosity increasing polymers having a viscosity of at least 1,000 cP at 25° C., when dissolved in water, at a concentration of about 2% (w/v);
(e) said one or more viscosity increasing polymers being in a total amount of between 3 wt % and 20 wt % out of the total dry weight of the blend;
(f) forming a film from said emulsion composition; and
(g) at least partially drying the film to obtain said plant-based edible hydrogel film, optionally folding said film into a folded film prior to at least partially drying the film.

98. The method of claim 97, wherein said forming of the film is by spreading a mass of the emulsion composition onto a film forming bed or within a mold, optionally comprising controlling thickness of the film, optionally wherein said controlling of thickness of the film is by using a gap applicator.

99. The method of claim 97, wherein said at least partially drying of the film is by exposing the film to a controlled heat, optionally wherein said at least partially drying the film is by any one or combination of heating the film within an oven, exposing the film to drying air, exposing the film to infrared (IR) radiation or heating within a microwave, optionally wherein said at least partially drying of the film is until water content within the film is between 20% and 90%.

100. A method of producing a plant-based food product, the method comprising
(i) providing one or more emulsion compositions comprising a homogenous blend of at least one hydrocolloid forming polymer, a protein, a lipid and water; wherein
(a) said at least one hydrocolloid forming polymer comprises one or more viscosity increasing polymers, each viscosity increasing polymers having a viscosity of at least 1,000 cP at 25° C., when dissolved in water, at a concentration of about 2% (w/v);
(b) said one or more viscosity increasing polymers being in a total amount of between 3 wt % and 20 wt % out of the total dry weight of the food product;
(ii) forming a first film from one of the emulsion compositions;
(iii) placing on said first film at least one additional film;
wherein each film can be the same or different from a previously placed film; and
wherein each additional film is formed on a previously applied film after said previously applied film is at least partially dried.

101. The method of claim 100, (i) comprising stacking a plurality of films one on top of another, (ii) wherein at least part of the plurality of films are formed prior to being stacked one on top of another, (iii) wherein at least part of the films are formed by spreading the emulsion composition onto a film forming bed or within a mold to form a film with a defined thickness and at least partially drying the thus formed film.
